(19) United States
(12) Patent Application Publication
(10) Pub. No.: US 2026/0035497 A1
(43) Pub. Date: Feb. 5, 2026

(54) AMINE CONTAINING COPOLYMERS VIA EMULSION POLYMERIZATION AND METHODS OF USE THEREOF

(71) Applicant: Infineum International Limited, linden, NJ (US)

(72) Inventors: Evan Haidasz, Hoboken, NJ (US); Ewan Galbraith, Kingston, NY (US); Pui Lam Chiu, Short Hills, NJ (US); Eric Silver, Jersey City, NJ (US); Nga Nguyen, Scotch Plains, NJ (US)

(73) Assignee: Infineum International Limited, linden, NJ (US)

(21) Appl. No.: 19/284,884

(22) Filed: Jul. 30, 2025

Related U.S. Application Data
(60) Provisional application No. 63/678,233, filed on Aug. 1, 2024.

(51) Int. Cl. C08F 220/18; C08F 2/26

(52) U.S. Cl. CPC C08F 220/1804; C08F 2/26; C08F 220/1808

(57) ABSTRACT

Disclosed herein are aqueous based copolymer emulsion compositions based on emulsion polymerization of monomer compositions including an amine-derivatized alpha-methyl styrene (ADAMS) monomer according to structure (I):

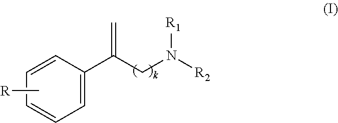

with k, R, R₁, and R₂ defined herein. The aqueous based copolymer emulsion compositions include (i) from 1 to 60 wt. % of the one or more copolymers, (ii) from 0.05 to 5.0 wt. % of one or more one or more surfactants selected from the group consisting of anionic surfactants, cationic surfactants, nonionic surfactants, amphoteric surfactants, and combinations thereof; and (iii) the remainder of the composition comprising water. Further disclosed herein are methods of making and methods for using such aqueous based copolymer emulsion compositions.

### CROSS-REFERENCE TO RELATED APPLICATION

This U.S. Non-provisional application claims priority to U.S. Provisional Application Ser. No. 63/678,233 filed on Aug. 1, 2024, the contents of which are herein incorporated by reference in their entirety.

### FIELD

This disclosure relates to aqueous emulsions of amine containing copolymers derived from monomer compositions containing aromatic structures each containing at least one aminic nitrogen. More particularly, this disclosure relates to amine containing copolymer emulsion compositions including one or more amine containing copolymers, one or more surfactants and water derived directly from emulsion polymerization. This disclosure also relates to methods of using such copolymer emulsions.

### BACKGROUND

There are myriad references disclosing nitrogen-containing (amine) groups pendant to the phenyl ring in styrenic monomers/polymers/copolymers. However, monomers and polymers bearing such pendant groups can be chemically difficult to synthesize reliably/repetitively. Even when such synthesis can be accomplished, there can be issues with propagation within the polymerization reactions containing such amine-functionalized styrenic monomers, whether alone or as copolymer with other styrenic monomers.

Thus, frequently the amine group can be added to a smattering of monomer repeat units using post-polymerization chemical reactions. But post-polymerization chemistry can often come through with different issues, even if it may avoid the propagation issues of amine-functionalized styrenic monomers.

As such, it is desirable to develop an unconventional way to functionalize a styrenic monomer pre-polymerization, particularly one that was neutral to, or perhaps even enhanced, the propagation within the polymerization reaction.

U.S. Pat. Nos. 6,486,272, 9,364,825, 10,202,494, and 10,046,285, disclose polymers made from styrenic monomers bearing nitrogen-containing groups pendant to the phenyl ring, all of which are herein incorporated by reference in their entirety. GB Patent No. 1 381 755 discloses amine-functional monomer compounds, but only with acrylamide functionality. Other examples of potentially relevant publications include, but are not necessarily limited to, U.S. Pat. Nos. 7,790,661, 7,960,320, 8,778,854, and 10,414,999; and PCT Publication No. WO 2021/127183, all of which are herein incorporated by reference in their entirety.

Based on the difficulty of preparing and polymerizing styrenic monomers bearing nitrogen-containing groups pendant to the phenyl ring, Applicant has explored other potential structures for functional monomers which are both simpler to manufacture and also polymerize. These functional monomer compositions containing aromatic and/or conjugated (non-aromatic) structures each containing at least one aminic nitrogen are described in commonly owned related U.S. Provisional Application Ser. No. 63/483,365 filed on Feb. 6, 2023, the contents of which are herein incorporated by reference in their entirety.

U.S. Pat. No. 2,778,826 (“the '826 Schmidle patent”) and a 1955 article by Schmidle and Mansfield, entitled “The Aminomethylation of Olefins. I. The Reaction of Secondary Amines, Formaldehyde, and Olefins,” both disclose various reactions alleging formation of 3-aryl-3-butenyl-1-amines, in which the formaldehyde and secondary amine allegedly formed an iminium, which reacted with the styrenic olefin to form only the terminal (vinylidene) double-bond version of the amine-functional styrenic. The 1955 article also disclosed amine-functionalization of terpenoids such as α- and β-pinene, camphene, and limonene, but not isoprene or similar conjugated non-aromatic compounds.

1983 article by Cohen and Onopchenko, entitled “Competing Hydride Transfer and Ene Reactions in the Aminoalkylation of 1-Alkenes with N,N-Dimethylmethyleniminium Ions. A Literature Correction” (citing, in part, to the '826 Schmidle patent, inter alia), further disclosed a mechanistic study of specifically dimethyliminimum compounds reacting with styrenic and non-styrenic olefins. Notably, at the beginning of the Discussion section, the 1983 article opines that the '826 Schmidle patent (and presumably the 1955 article containing strikingly similar experiments and results thereto) had made mistakes. Nonetheless, with respect to aminomethylation of α-methylstyrene, the 1983 article indicated formation of vinylidene-based product, in tandem with a significant vinylene (not terminal double-bond) content and a quite significant (13%, in the case of the dimethylamino-version) saturated arylalkane-amine content.

The inventive monomers disclosed in U.S. Provisional Application Ser. No. 63/483,365 have, to the best of the Applicant's knowledge, not been previously polymerized.

Secondary metal ion batteries include both an anode and a cathode. These electrodes are typically coated with a polymer-based slurry composition that serves to form a uniform layer of active material that adheres to the current collector and retains structural integrity during the lifetime of the battery. Silicon has been extensively pioneered to be the next most important anode material used in secondary lithium-ion battery (LiB) to replace graphite due to the added high capacity (×4) and fast charging capabilities (via thinner electrode). The addition of a low level of Si (˜5%) to anode formulations have been proven to meet 3rd generation electric vehicle (EV) targets in terms of battery performance. However, at higher Si level, Si-anode materials experience high volume changes (4×) during lithiation-delithiation which leads to the following issues: (1) pulverization or cracking of Si particles; (2) delamination of functional coating from the current collector; (3) unstable solid-electrolyte interface. These problems cannot be resolved using currently available polymeric binder materials, which are predominately styrene butadiene rubber (SBR) in combination with CMC (carboxymethyl cellulose) or PAA (polyacrylic acid) as co-binders materials in the polymer based slurry for coating on the battery anode.

Hence, there is a need for improved functional polymeric binder materials based on alpha-substituted functional monomers, and in particular functional polymers based on functional monomer compositions containing aromatic structures each containing at least one aminic nitrogen for use in slurries used in coating battery electrodes to improve the overall performance of the battery in terms of life. The polymeric binders are typically introduced into the slurries as polymer emulsions in water to both aid in handleability, and the mixing process to form homogenous blends prior to coating the electrode.

There is also a need for improved aqueous emulsions of amine containing copolymers derived from monomer compositions containing aromatic structures each containing at least one aminic nitrogen for use in other applications, including, but not limited to, as a plastic additive, a drag reducing agent, a magneto-rheological fluid, an electro-chlorination additive, an industrial coating additive, an adhesive additive, an asphaltene and wax inhibitor, a refinery anti-foulant, an industrial or household surfactant, an agrochemical additive, a ceramic capacitor or indictor additive, an emulsion explosive additive, an anti-microbial coating, a crude transportation and refining additive, and a carbon-capture additive.

There is also a need to provide functional polymers based on alpha-substituted functional monomers, and in particular functional polymers based on functional monomer compositions containing aromatic structures each containing at least one aminic nitrogen utilizing emulsion polymerization processing techniques.

### SUMMARY

Accordingly, the present disclosure provides inventive copolymer emulsion compositions based on emulsion polymerization of monomer compositions including an amine-derivatized alpha-methyl styrene (ADAMS) monomer according to structure (I):

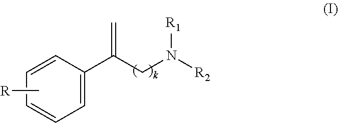

with k, R, R₁, and R₂ defined herein. Further disclosed herein are methods of making and methods for using such copolymer compositions.

In one form, disclosed herein is an aqueous based copolymer emulsion compositions based on emulsion polymerization of monomer compositions including an amine-derivatized alpha-methyl styrene (ADAMS) monomer according to structure (I):

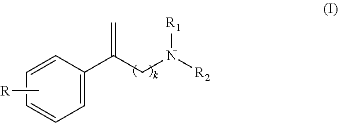

with k, R, R₁, and R₂ defined herein. The aqueous based copolymer emulsion compositions include (i) from 1 to 60 wt. % of the one or more copolymers, (ii) from 0.05 to 5.0 wt. % of one or more one or more surfactants selected from the group consisting of anionic surfactants, cationic surfactants, nonionic surfactants, amphoteric surfactants, and combinations thereof; and (iii) the remainder of the composition comprising water. Further disclosed herein are methods of making and methods for using such aqueous based copolymer emulsion compositions.

According to the present disclosure, provided is an advantageous aqueous based copolymer emulsion composition comprising:
i) from 1 to 60 wt. % of one or more copolymers comprising:
   (a) one or more amine-derivatized alpha-methyl styrene (ADAMS) repeat units according to structure (II):

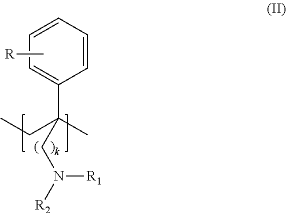

wherein: k is an integer from 1 to 3; R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof; R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof;
   (b) one or more repeat units selected from the group of structures (III):

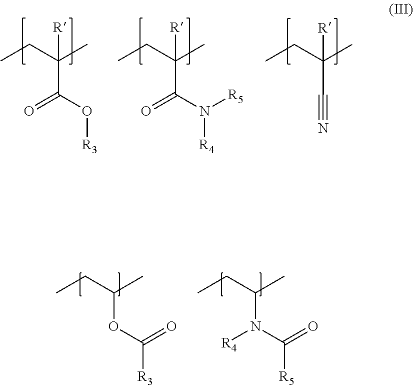

and combinations thereof, wherein: R′ is a hydrogen or methyl group; R₃, R₄, and R₅ are each independently a hydrogen atom, a hydrocarbyl group having 1 to 30 carbon atoms, or a hydrocarbonaceous group having 1 to 30 carbon atoms and 1 to 6 additional heteroatoms selected from the group consisting of O, N, S, P, Si, and combinations thereof, or wherein R₃ is a hydrocarbyl or hydrocarbonaceous polymer having number-average molecular weight below 10,000 Da and optionally additional heteroatoms selected from the group of O, N, S, P, Se, or a combination thereof, or
wherein R₄ and R₅ are connected to form a moiety containing at least one 5- to 12-membered ring, from 3 to 30 carbon atoms, and optionally 1 to 6 additional heteroatoms selected from the group consisting of O, N, S, P, Si, or a combination thereof; and
(ii) from 0.05 to 5.0 wt. % of one or more one or more surfactants selected from the group consisting of anionic surfactants, cationic surfactants, nonionic surfactants, amphoteric surfactants, and combinations thereof; and
(iii) the remainder of the composition comprising water.

According to the present disclosure, provided is also an aqueous based copolymer emulsion composition comprising:
i) from 1 to 60 wt. % of one or more copolymers comprising:
   (a) the reaction product of one or more monomers according to structure (I)

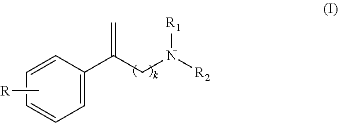

wherein: k is an integer from 1 to 3; R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof; R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof; and
   (b) the reaction product of one or more monomers selected from the group consisting of optionally substituted acrylates, methacrylates, acrylamides, methacrylamides, acrylonitriles, methacrylonitriles, 0-vinyl esters, N-vinyl amides, or combinations thereof;
(ii) from 0.05 to 5.0 wt. % of one or more surfactants selected from the group consisting of anionic surfactants, cationic surfactants, nonionic surfactants, amphoteric surfactants, and combinations thereof; and
(iii) the remainder of the composition comprising water.

A further aspect of the present disclosure relates to an advantageous method of making an amine containing copolymer via emulsion polymerization comprising the steps of:
(a) preparing a monomer emulsion mixture by combining one or more radically polymerizable monomers comprising
i) one or more monomers according to structure (I)

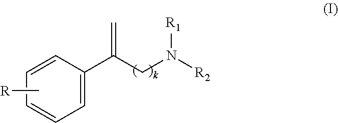

wherein:
k is an integer from 1 to 3;
R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof;
ii) one or more monomers selected from the group consisting of optionally substituted acrylates, methacrylates, acrylamides, methacrylamides, acrylonitriles, methacrylonitriles, 0-vinyl esters, N-vinyl amides, or combinations thereof; and
iii) one or more first emulsifiers in water, and optionally one or more pH buffers, and optionally one or more reaction modifiers;
(b) combining water, and optionally one or more second emulsifiers, and optionally one or more pH buffers, and the monomer emulsion mixtures of step (a) in a continuous or discontinuous manner to form a polymerization reaction mixture;
(c) adding one or more radical initiators, or a solution of one or more radical initiators, in a continuous or discontinuous manner, to the polymerization reaction mixture of step (b); and
(d) heating or cooling the polymerization reaction mixture of step (c) to a sufficient temperature, and for a sufficient time to form an amine containing copolymer.

A still further aspect of the present disclosure relates to an advantageous method of using an aqueous based copolymer emulsion composition comprising: providing the an aqueous based copolymer emulsion composition according to the above paragraphs, or an additive mixture including the aqueous based copolymer emulsion composition according to the above paragraphs, and using the copolymer emulsion or the additive mixture including the copolymer emulsion in an application selected from the group consisting of an adhesive additive, a lithium-ion battery additive, a plastic additive, a drag reducing agent, a magneto-rheological fluid, an electro-chlorination additive, an industrial coating additive, an asphaltene and wax inhibitor, a refinery anti-foulant, an industrial or household surfactant, an agrochemical additive, a ceramic capacitor or inductor additive, an emulsion explosive additive, an anti-microbial coating, a crude transportation and refining additive, a carbon-capture additive, or a construction material additive.

Other aspects of the present disclosure may become apparent from the Detailed Description and Examples sections hereinbelow.

### DETAILED DESCRIPTION

All numerical values within the detailed description and the claims herein are modified by “about” or “approximately” the indicated value, and take into account experimental error and variations that would be expected by a person having ordinary skill in the art.

### Overview

The present disclosure provides novel aqueous based amine containing copolymer emulsion compositions derived from monomer compositions containing aromatic structures each containing at least one aminic nitrogen derived directly from emulsion polymerization processing. The amine containing copolymer emulsion compositions disclosed herein include surfactant and water, and find particular application as a binder or co-binder for secondary metal ion battery electrodes. Other uses include, but are not limited to, use as a plastic additive, a drag reducing agent, a magneto-rheological fluid, an electro-chlorination additive, an industrial coating additive, an adhesive additive, an asphaltene and wax inhibitor, a refinery anti-foulant, an industrial or household surfactant, an agrochemical additive, a ceramic capacitor or indictor additive, an emulsion explosive additive, an anti-microbial coating, a crude transportation and refining additive, and a carbon-capture additive.

In such application as a binder or co-binder for secondary metal ion battery electrodes, the aqueous based amine containing copolymer emulsion compositions provided herein, provide the following advantages including, but not limited to: improved battery life, improved structural/mechanical integrity of the anode, enhanced charging rate capability and capacity retention, and enhanced processability. The aqueous based amine containing copolymer emulsion compositions disclosed herein may be blended with other components, including, but not limited to, one or more co-binders, one or more conductive carbon-based particles, and one or more of silicon-based particles to form an electrode slurry composition. Also provided herein are methods of improving the life of a secondary metal ion battery by using the electrode slurry composition disclosed herein as a binder for a coating of an anode of the secondary metal ion battery.

The present disclosure also provides methods of making an aqueous based amine containing copolymer emulsions via emulsion polymerization and methods of making an electrode slurry composition for a secondary metal ion battery. The present disclosure also provides methods of using an aqueous based amine containing copolymer emulsion composition and methods of using an electrode slurry composition including the aqueous based amine containing copolymer emulsion as binder or a co-binder for an electrode of a secondary metal ion battery. The present disclosure also provides for a secondary metal ion battery anode that includes one or more copolymer binders or co-binders comprising the aqueous based amine containing copolymer emulsions disclosed herein.

The compositions and methods provided herein are distinguishable over the prior art by including novel aqueous based amine containing copolymer emulsion compositions derived directly from emulsion polymerization processing, which offer significant advantages relative to prior art polymer emulsion compositions including styrene-butadiene rubber and carboxymethyl cellulose.

The advantageous properties and/or characteristics of the disclosed novel aqueous based amine containing copolymer emulsion compositions as binders or co-binders in secondary metal ion battery electrode application include, inter alia, improved battery life, improved structural/mechanical integrity of the anode, enhanced charging rate capability and capacity retention, and enhanced processability.

### Amine Containing Copolymer Emulsion Compositions

i. ADAMS Copolymer Embodiment

In one embodiment, disclosed herein are aqueous based amine containing copolymer emulsion compositions including:
i) from 1 to 60 wt. %, or 2 to 50 wt. %, or 4 to 40 wt. %, or 6 to 30 wt. %, or 8 to 25 wt. %, or 10 to 20 wt. %, or 13 to 17 wt. % of one or more copolymers comprising: (a) one or more amine-derivatized alpha-methyl styrene (ADAMS) repeat units according to structure (II):

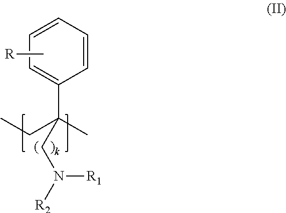

wherein:
   k is an integer from 1 to 3, or k=2;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof; and
(b) one or more repeat units selected from the group of structures (III):

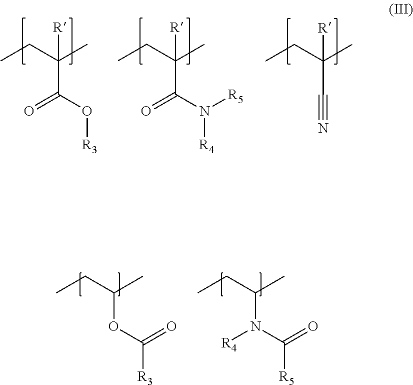

and combinations thereof, wherein: PGP-2
   R′ is a hydrogen or methyl group;
   R₃, R₄, and R₅ are each independently a hydrogen atom, a hydrocarbyl group having 1 to 30 carbon atoms, or a hydrocarbonaceous group having 1 to 30 carbon atoms and 1 to 6 additional heteroatoms selected from the group consisting of O, N, S, P, Si, and combinations thereof, or
   wherein R₃ is a hydrocarbyl or hydrocarbonaceous polymer having number-average molecular weight below 10,000 Da and optionally additional heteroatoms selected from the group of O, N, S, P, Se, or a combination thereof, or
   wherein R₄ and R₅ are connected to form a moiety containing at least one 5- to 12-membered ring, from 3 to 30 carbon atoms, and optionally 1 to 6 additional heteroatoms selected from the group consisting of O, N, S, P, Si, or a combination thereof; and
ii) from 0.05 to 5.0 wt. %, or 0.1 to 4.5 wt. %, or 0.5 to 4.0 wt. %, or 1.0 to 3.5 wt. %, or 1.5 to 3.0 wt. %, or 2.0 to 2.5 wt. % of one or more one or more surfactants selected from the group consisting of anionic surfactants, cationic surfactants, nonionic surfactants, amphoteric surfactants, and combinations thereof; and
iii) the remainder of the composition comprising water.

In this embodiment, when k=2, the one or more ADAMS repeat units according to structure (II) above may comprise the reacted form of 1-dimethylamino-3-phenylbut-3-ene, 1-diethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl)amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-phenylbut-3-ene, 1-(N-piperidinyl)-3-phenylbut-3-ene, 1-(N-piperazinyl)-3-phenylbut-3-ene, 1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazinyl)-3-phenylbut-3-ene, 1-(5-methyl-2,5-diazabicyclo[2.2.1]heptan-2-yl)-3-phenylbut-3-ene, 1-(5-methyl-2,5-diazabicyclo[2.2.2]octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1-piperazinyl)-3-phenylbut-3-ene, 1-(N′-methyl-N-diazepanyl)-3-phenylbut-3-ene, N,N′-bis(3-phenylbut-3-enyl)diazepane, N,N′-bis(3-phenylbut-3-enyl)piperazine, N,N′-bis(3-phenylbut-3-enyl)dihydrophenazine, N,N′-bis(3-phenylbut-3-enyl)dihydrobenzoindazole, N,N′-bis(3-phenylbut-3-enyl)dihydropermidine, N,N′-bis(3-phenylbut-3-enyl)octahydropyridoquinoline, N,N′-bis(3-phenylbut-3-enyl)octahydropyridoisoquinoline, N,N′-bis(3-phenylbut-3-enyl)hexahydropyrroloquinoline, N,N′-bis(3-phenylbut-3-enyl)hexahydropyrroloisoquinoline, N,N′-bis(3-phenylbut-3-enyl)hexahydropyrroloisoindole, N,N′-bis(3-phenylbut-3-enyl)diazabicyclo[2.2.1]heptane, N,N′-bis(3-phenylbut-3-enyl)diazabicyclo[2.2.2]octane, 1,3-bis(1-(3-phenylbut-3-enyl)piperidin-4-yl)propane, bis(1-dimethylamino-3-phenylbut-3-enyl)benzene, bis(1-benzylmethylamino-3-phenylbut-3-enyl)benzene, bis(1-(N-morpholinyl)-3-phenylbut-3-enyl)benzene, bis(1-(N-thiomorpholinyl)-3-phenylbut-3-enyl)benzene, bis(1-(di-methoxyethyl)amino-3-phenylbut-3-enyl)benzene, bis(1-(N-piperidinyl)-3-phenylbut-3-enyl)benzene, bis(1-(N-pyrrolidinyl)-3-phenylbut-3-enyl)benzene, bis(1-(4-methyl-1-piperazinyl))-3-phenylbut-3-enyl)benzene, or a combination thereof.

In this embodiment, the one or more repeat units according to structure (III) above may comprise the reacted form of acrylates, methacrylates, acrylamides, methacrylamides, acrylonitriles, methacrylonitriles, 0-vinyl esters, N-vinyl amides, or combinations thereof.

Alternatively, for this this embodiment, the one or more repeat units according to structure (III) may comprise the reacted form of the following exemplary monomers: methyl acrylate, ethyl acrylate, propyl acrylate, n-butyl acrylate, s-butyl acrylate, t-butyl acrylate, n-pentyl acrylate, cyclopentyl acrylate, n-hexyl acrylate, cyclohexyl acrylate, phenyl acrylate, benzyl acrylate, n-octyl acrylate, 2-ethylhexyl acrylate, decyl acrylate, lauryl acrylate, stearyl acrylate, 2-methoxyethyl acrylate, 2-ethoxyethyl acrylate, 2-phenoxyethyl acrylate, 2-benzyloxyethyl acrylate, 2-(naphthalen-1-yloxy)ethyl acrylate, 2-(naphthalen-2-yloxy)ethyl acrylate, 2-dimethylaminoethyl acrylate, 2-diethylaminoethyl acrylate, 2-(piperidin-1-yloxy)ethyl acrylate, 2-(morpholin-1-yloxy)ethyl acrylate, methyl methacrylate, ethyl methacrylate, propyl methacrylate, n-butyl methacrylate, s-butyl methacrylate, t-butyl methacrylate, n-pentyl methacrylate, cyclopentyl methacrylate, n-hexyl methacrylate, cyclohexyl methacrylate, phenyl methacrylate, benzyl methacrylate, n-octyl methacrylate, 2-ethylhexyl methacrylate, decyl methacrylate, lauryl methacrylate, stearyl methacrylate, 2-methoxyethyl methacrylate, 2-ethoxyethyl methacrylate, 2-phenoxyethyl methacrylate, 2-benzyloxyethyl methacrylate, 2-(naphthalen-1-yloxy)ethyl methacrylate, 2-(naphthalen-2-yloxy)ethyl methacrylate, 2-dimethylaminoethyl methacrylate, 2-diethylaminoethyl methacrylate, 2-(piperidin-1-yloxy)ethyl methacrylate, 2-(morpholin-1-yloxy)ethyl methacrylate, vinyl acetate, vinyl propanoate, vinyl butyrate, vinyl benzoate, N-vinyl formamide, N-vinyl acetamide, N-vinyl propionamide, N-vinyl butyramide, N-vinyl benzamide, N-vinyl pyrrolidine-2-one, N-vinyl piperidin-2-one, acrylonitrile, methacrylonitrile, or combinations thereof.

Still alternatively, for this embodiment, the one or more repeat units according to structure (III) may comprise the reacted form of optionally substituted acrylates, methacrylates, acrylamides, or methacrylamides, which comprise a polymer unit further comprising polyethylene, polypropylene, polyisobutylene, polybutadiene, polyisoprene, polyfarnesene, polystyrene, polyethylene glycol, polypropylene glycol, or combinations thereof.

In some embodiments, the inventive aqueous based amine containing copolymer emulsion compositions disclosed herein based on the functionalized styrenic monomers including a nitrogen-containing moiety, other than as pendant to the phenyl ring may be polymerized from the exemplary ADAMS monomers according to structure (I), may exhibit a k value of exactly 2.

For clarity, and as used herein, the inventive aqueous based amine containing copolymer emulsion compositions disclosed herein based on the functionalized styrenic monomers including a nitrogen-containing moiety, other than as pendant to the phenyl ring may be polymerized from the exemplary ADAMS monomers of structure (I) having a vinylidene bond, such as originating from the olefinic double-bond in alpha-methylstyrene, which can be reflected in -3-ene/-3-enyl language of the IUPAC nomenclature, for example.

In this embodiment, the inventive aqueous based amine containing copolymer emulsion compositions may further comprise one or more additional repeat units comprising the reacted form of styrene, alpha-methylstyrene, para-methylstyrene, 2-vinylpyridine, 3-vinylpyridine, 4-vinylpyridine, or a combination thereof.

In this embodiment, the aqueous based amine containing copolymer emulsion compositions may further comprise one or more additional repeat units according to structure (IV) below:

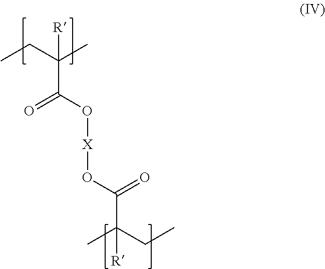

wherein: R′ is a hydrogen or methyl; X is a hydrocarbyl group or a hydrocarbonaceous group having 1 to 20 additional heteroatoms selected from the group consisting of O, N, S, P, Se, and combinations thereof, or wherein X is a hydrocarbyl or hydrocarbonaceous polymer having number-average molecular weight below 10,000 Da and optionally additional heteroatoms selected from the group of O, N, S, P, Se, or a combination thereof.

Alternatively, in this embodiment, the aqueous based amine containing copolymer emulsion compositions may have an amino group in one or more repeat units of structure (II) which are protonated or alkylated to their corresponding ammonium salt. In this form, the protonated or alkylated ammonium salt may comprise a chloride, bromide, iodide, alkyl or aryl sulfonate, sulfate, phosphate, formate, acetate, propionate, butyrate, benzoate, triflate, nitrate counterion, or a combination thereof.

In this embodiment, the aqueous based amine containing copolymer emulsion compositions disclosed herein may include one or more surfactants, and more particularly, one or more anionic surfactants, cationic surfactants, nonionic surfactants, amphoteric surfactants, and combinations thereof. More particularly, the aqueous based amine containing copolymer emulsion compositions may include one or more anionic or cationic surfactants, including, but not limited to, sodium dodecyl sulfonate, alkyl surfactants, fluorine surfactants, metal surfactants, and combinations thereof. The aqueous based amine containing copolymer emulsion compositions may alternatively include one or more non-ionic surfactants chosen from silicone surfactants, fluorine surfactants, alkyl surfactants, polyether-based surfactants, and combinations thereof.

In this embodiment, the aqueous based amine containing copolymer emulsion compositions disclosed herein include the emulsified amine containing copolymer having a particle size ranging from 50 to 1000 nm, or 75 to 950 nm, or 100 to 900 nm, or 125 to 850 nm, or 150 to 800 nm, or 175 to 750 nm, or 200 to 700 nm, or 225 to 650 nm, or 250 to 600 nm, or 275 to 550 nm, or 300 to 500 nm, or 325 to 475 nm, or 350 to 450 nm, or 375 to 425 nm.

In this embodiment, the aqueous based amine containing copolymer emulsion compositions disclosed herein may have a pH ranging from 2.0 to 12.0, or 4.0 to 10.0, or 4.5 to 9.5, or 5.0 to 9.0, or 5.5 to 8.5, or 6.0 to 8.0, or 6.5 to 7.5. The aqueous based amine containing copolymer emulsion compositions disclosed herein may have a viscosity at 25 deg. C. as measured by ASTM D5133 of from 10 to 2000 cP, or 15 to 1500 cP, or 20 to 1000 cP, or 30 to 950 cP, or 40 to 900 cP, or 50 to 850 cP, or 60 to 800 cP, or 70 to 750 cP, or 80 to 700 cP, or 90 to 650 cP, or 100 to 600 cP, or 150 to 550 cP, or 200 to 500 cP, or 250 to 450 cP, or 300 to 400 cP.

In this embodiment, the aqueous based amine containing copolymer emulsion compositions disclosed herein when formed into a polymer film may have an electrical conductivity from 0.00001 to 1 mS/cm, or 0.00005 to 0.5 mS/cm, or 0.0001 to 0.1 mS/cm, or 0 mS/cm.

In this embodiment, the aqueous based amine containing copolymer emulsion compositions disclosed herein may include one or more copolymers having a number average molecular weight of from 2000 daltons to 5,000,000 daltons, or 5000 daltons to 4,000,000 daltons, or 10,000 daltons to 3,000,000 daltons, or 20,000 daltons to 2,000,000 daltons, or 50,000 daltons to 1,000,000 daltons, or 100,000 daltons to 800,000 daltons, or 200,000 daltons to 600,000 daltons, or 300,000 daltons to 500,000 daltons.

ii. ADAMS Reaction Product Embodiment

In another embodiment, disclosed herein are aqueous based amine containing copolymer emulsion compositions comprising:
i) from 1 to 60 wt. %, or 2 to 50 wt. %, or 4 to 40 wt. %, or 6 to 30 wt. %, or 8 to 25 wt. %, or 10 to 20 wt. %, or 13 to 17 wt. % of one or more copolymers comprising:
   (a) the reaction product of one or more monomers according to structure (I)

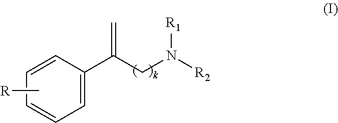

wherein:
   k is an integer from 1 to 3; or k=2;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof; and
   (b) the reaction product of one or more monomers selected from the group consisting of optionally substituted acrylates, methacrylates, acrylamides, methacrylamides, acrylonitriles, methacrylonitriles, 0-vinyl esters, N-vinyl amides, or combinations thereof;
(ii) 0.05 to 5.0 wt. %, or 0.1 to 4.5 wt. %, or 0.5 to 4.0 wt. %, or 1.0 to 3.5 wt. %, or 1.5 to 3.0 wt. %, or 2.0 to 2.5 wt. % of one or more one or more surfactants selected from the group consisting of anionic surfactants, cationic surfactants, nonionic surfactants, amphoteric surfactants, and combinations thereof; and
(iii) the remainder of the composition comprising water.

In this embodiment, when k=2, the monomers according to structure (I) above may comprise 1-dimethylamino-3-phenylbut-3-ene, 1-diethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl)amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-phenylbut-3-ene, 1-(N-piperidinyl)-3-phenylbut-3-ene, 1-(N-piperazinyl)-3-phenylbut-3-ene, 1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazinyl)-3-phenylbut-3-ene, 1-(5-methyl-2,5-diazabicyclo[2.2.1]heptan-2-yl)-3-phenylbut-3-ene, 1-(5-methyl-2,5-diazabicyclo[2.2.2]octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1-piperazinyl)-3-phenylbut-3-ene, 1-(N′-methyl-N-diazepanyl)-3-phenylbut-3-ene, N,N′-bis(3-phenylbut-3-enyl)diazepane, N,N′-bis(3-phenylbut-3-enyl)piperazine, N,N′-bis(3-phenylbut-3-enyl)dihydrophenazine, N,N′-bis(3-phenylbut-3-enyl)dihydrobenzoindazole, N,N′-bis(3-phenylbut-3-enyl)dihydropermidine, N,N′-bis(3-phenylbut-3-enyl)octahydropyridoquinoline, N,N′-bis(3-phenylbut-3-enyl)octahydropyridoisoquinoline, N,N′-bis(3-phenylbut-3-enyl)hexahydropyrroloquinoline, N,N′-bis(3-phenylbut-3-enyl)hexahydropyrroloisoquinoline, N,N′-bis(3-phenylbut-3-enyl)hexahydropyrroloisoindole, N,N′-bis(3-phenylbut-3-enyl)diazabicyclo[2.2.1]heptane, N,N′-bis(3-phenylbut-3-enyl)diazabicyclo[2.2.2]octane, 1,3-bis(1-(3-phenylbut-3-enyl)piperidin-4-yl)propane, bis(1-dimethylamino-3-phenylbut-3-enyl)benzene, bis(1-benzylmethylamino-3-phenylbut-3-enyl)benzene, bis(1-(N-morpholinyl)-3-phenylbut-3-enyl)benzene, bis(1-(N-thiomorpholinyl)-3-phenylbut-3-enyl)benzene, bis(1-(di-methoxyethyl)amino-3-phenylbut-3-enyl)benzene, bis(1-(N-piperidinyl)-3-phenylbut-3-enyl)benzene, bis(1-(N-pyrrolidinyl)-3-phenylbut-3-enyl)benzene, bis(1-(4-methyl-1-piperazinyl))-3-phenylbut-3-enyl)benzene, or a combination thereof.

Alternatively, for this this embodiment, the one or more monomers selected from the group consisting of optionally substituted acrylates, methacrylates, acrylamides, methacrylamides, acrylonitriles, methacrylonitriles, O-vinyl esters, N-vinyl amides, or combinations thereof, may be selected from the following exemplary monomers: methyl acrylate, ethyl acrylate, propyl acrylate, n-butyl acrylate, s-butyl acrylate, t-butyl acrylate, n-pentyl acrylate, cyclopentyl acrylate, n-hexyl acrylate, cyclohexyl acrylate, phenyl acrylate, benzyl acrylate, n-octyl acrylate, 2-ethylhexyl acrylate, decyl acrylate, lauryl acrylate, stearyl acrylate, 2-methoxyethyl acrylate, 2-ethoxyethyl acrylate, 2-phenoxyethyl acrylate, 2-benzyloxyethyl acrylate, 2-(naphthalen-1-yloxy)ethyl acrylate, 2-(naphthalen-2-yloxy)ethyl acrylate, 2-dimethylaminoethyl acrylate, 2-diethylaminoethyl acrylate, 2-(piperidin-1-yloxy)ethyl acrylate, 2-(morpholin-1-yloxy)ethyl acrylate, methyl methacrylate, ethyl methacrylate, propyl methacrylate, n-butyl methacrylate, s-butyl methacrylate, t-butyl methacrylate, n-pentyl methacrylate, cyclopentyl methacrylate, n-hexyl methacrylate, cyclohexyl methacrylate, phenyl methacrylate, benzyl methacrylate, n-octyl methacrylate, 2-ethylhexyl methacrylate, decyl methacrylate, lauryl methacrylate, stearyl methacrylate, 2-methoxyethyl methacrylate, 2-ethoxyethyl methacrylate, 2-phenoxyethyl methacrylate, 2-benzyloxyethyl methacrylate, 2-(naphthalen-1-yloxy)ethyl methacrylate, 2-(naphthalen-2-yloxy)ethyl methacrylate, 2-dimethylaminoethyl methacrylate, 2-diethylaminoethyl methacrylate, 2-(piperidin-1-yloxy)ethyl methacrylate, 2-(morpholin-1-yloxy)ethyl methacrylate, vinyl acetate, vinyl propanoate, vinyl butyrate, vinyl benzoate, N-vinyl formamide, N-vinyl acetamide, N-vinyl propionamide, N-vinyl butyramide, N-vinyl benzamide, N-vinyl pyrrolidine-2-one, N-vinyl piperidin-2-one, acrylonitrile, methacrylonitrile, or combinations thereof.

Still alternatively, for this this embodiment, the one or more monomers selected from the group consisting of optionally substituted acrylates, methacrylates, acrylamides, methacrylamides, acrylonitriles, methacrylonitriles, 0-vinyl esters, N-vinyl amides, or combinations thereof; may comprise a polymer unit further comprising polyethylene, polypropylene, polyisobutylene, polybutadiene, polyisoprene, polyfarnesene, polystyrene, polyethylene glycol, polypropylene glycol, or combinations thereof.

In some embodiments, the inventive aqueous based amine containing copolymer emulsion compositions disclosed herein based on the functionalized styrenic monomers including a nitrogen-containing moiety, other than as pendant to the phenyl ring may be polymerized from the exemplary ADAMS monomers according to structure (I), may exhibit a k value of exactly 2.

For clarity, and as used herein, the inventive aqueous based amine containing copolymer emulsion compositions disclosed herein based on the functionalized styrenic monomers including a nitrogen-containing moiety, other than as pendant to the phenyl ring may be polymerized from the exemplary ADAMS monomers of structure (I) having a vinylidene bond, such as originating from the olefinic double-bond in alpha-methylstyrene, which can be reflected in -3-ene/-3-enyl language of the IUPAC nomenclature, for example.

In this embodiment, the aqueous based amine containing copolymer emulsion compositions may further comprise the reacted form of styrene, alpha-methylstyrene, para-methylstyrene, 2-vinylpyridine, 3-vinylpyridine, 4-vinylpyridine, or a combination thereof.

In this embodiment, the aqueous based amine containing copolymer emulsion compositions may further comprise the reacted form of one or more monomers according to structure (V) below:

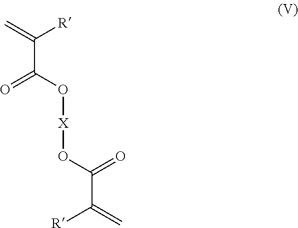

wherein: R′ is a hydrogen or methyl; X is a hydrocarbyl group or a hydrocarbonaceous group having 1 to 20 additional heteroatoms selected from the group consisting of O, N, S, P, Se, and combinations thereof, or wherein X is a hydrocarbyl or hydrocarbonaceous polymer having number-average molecular weight below 10,000 Da and optionally additional heteroatoms selected from the group of O, N, S, P, Se, or a combination thereof.

Alternatively, in this embodiment, the aqueous based amine containing copolymer emulsion compositions may have an amino group within the reacted form of the one or more monomers of structure (I) which are protonated or alkylated to their corresponding ammonium salt. In this form, the protonated or alkylated ammonium salt may comprise a chloride, bromide, iodide, alkyl or aryl sulfonate, sulfate, phosphate, formate, acetate, propionate, butyrate, benzoate, triflate, nitrate counterion, or a combination thereof.

In this embodiment, the aqueous based amine containing copolymer emulsion compositions disclosed herein may include one or more surfactants, and more particularly, one or more anionic surfactants, cationic surfactants, nonionic surfactants, amphoteric surfactants, and combinations thereof. More particularly, the aqueous based amine containing copolymer emulsion compositions may include one or more anionic or cationic surfactants, including, but not limited to, sodium dodecyl sulfonate, alkyl surfactants, fluorine surfactants, metal surfactants, and combinations thereof. The aqueous based amine containing copolymer emulsion compositions may alternatively include one or more non-ionic surfactants chosen from silicone surfactants, fluorine surfactants, alkyl surfactants, polyether-based surfactants, and combinations thereof. A

In this embodiment, the aqueous based amine containing copolymer emulsion compositions disclosed herein include the emulsified amine containing copolymer having a particle size ranging from 20 to 2000 nm, or 50 to 1000 nm, or 75 to 950 nm, or 100 to 900 nm, or 125 to 850 nm, or 150 to 800 nm, or 175 to 750 nm, or 200 to 700 nm, or 225 to 650 nm, or 250 to 600 nm, or 275 to 550 nm, or 300 to 500 nm, or 325 to 475 nm, or 350 to 450 nm, or 375 to 425 nm.

In this embodiment, the aqueous based amine containing copolymer emulsion compositions disclosed herein may have a pH ranging from 2.0 to 12.0, or 4.0 to 10.0, or 4.5 to 9.5, or 5.0 to 9.0, or 5.5 to 8.5, or 6.0 to 8.0, or 6.5 to 7.5. The aqueous based amine containing copolymer emulsion compositions disclosed herein may have a viscosity at 25 deg. C. as measured by ASTM D5133 of from 10 to 2000 cP, or 15 to 1500 cP, or 20 to 1000 cP, or 30 to 950 cP, or 40 to 900 cP, or 50 to 850 cP, or 60 to 800 cP, or 70 to 750 cP, or 80 to 700 cP, or 90 to 650 cP, or 100 to 600 cP, or 150 to 550 cP, or 200 to 500 cP, or 250 to 450 cP, or 300 to 400 cP.

In this embodiment, the aqueous based amine containing copolymer emulsion compositions disclosed herein when formed into a polymer film may have an electrical conductivity from 0 to 1 mS/cm, or 0.00001 to 1 mS/cm, or 0.00005 to 0.5 mS/cm, or 0.0001 to 0.1 mS/cm.

In this embodiment, the aqueous based amine containing copolymer emulsion compositions disclosed herein may include one or more copolymers having a number average molecular weight of from 2000 daltons to 5,000,000 daltons, or 5000 daltons to 4,000,000 daltons, or 10,000 daltons to 3,000,000 daltons, or 20,000 daltons to 2,000,000 daltons, or 50,000 daltons to 1,000,000 daltons, or 100,000 daltons to 800,000 daltons, or 200,000 daltons to 600,000 daltons, or 300,000 daltons to 500,000 daltons.

### Amine Containing Copolymers Formed Via Emulsion Polymerization

The aqueous based copolymer emulsion compositions disclosed herein utilize novel polymers based on emulsion polymerization of functionalized styrenic monomers including a nitrogen-containing moiety, other than as pendant to the phenyl ring. Thus, the monomers of structure (I) were developed to achieve nitrogen-containing functionality on an alpha-substituted styrenic monomer other than as pendant to the phenyl ring on the styrene unit.

It should be noted that prior art references often describe functionalized styrenic monomer with nitrogen containing groups pendant to the phenyl ring in general terms (e.g. “dimethylaminoethyl styrene”), which can be similar to the k=2 monomer structure provided below, however, the prior art does not teach or suggest the alpha-substituted functional monomers specifically disclosed herein.

The inventive aqueous based copolymer emulsion compositions disclosed herein utilizing functional polymers based on functionalized styrenic monomers including a nitrogen-containing moiety, other than as pendant to the phenyl ring, may be emulsion polymerized from addition-polymerizable monomer compositions including one or more amine-derivatized alpha-methyl styrene (ADAMS) monomers according to structure (I) below, wherein the emulsion composition includes:
(i) from 1 to 60 wt. % of one or more copolymers comprising:
   (a) the reaction product of

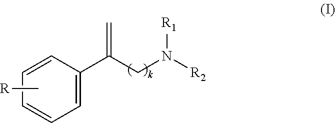

wherein k is an integer from 1 to 3, or k=2;
R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof; and
(b) the reaction product of one or more monomers selected from the group consisting of optionally substituted acrylates, methacrylates, acrylamides, methacrylamides, acrylonitriles, methacrylonitriles, 0-vinyl esters, N-vinyl amides, or combinations thereof;
(ii) from 0.05 to 5.0 wt. % of one or more one or more surfactants selected from the group consisting of anionic surfactants, cationic surfactants, nonionic surfactants, amphoteric surfactants, and combinations thereof; and
(iii) the remainder of the composition comprising water.

The inventive aqueous based copolymer emulsion compositions disclosed herein utilizing functional polymers based on functionalized styrenic monomers including a nitrogen-containing moiety, other than as pendant to the phenyl ring, may be preferentially polymerized via emulsion polymerization processes.

Provided herein are inventive aqueous based copolymer emulsion polymerized compositions utilizing polymers derived from functionalized styrenic monomers including a nitrogen-containing moiety, other than as pendant to the phenyl ring. More particularly, the functionalized styrenic monomers including a nitrogen-containing moiety, other than as pendant to the phenyl ring have the general structure:

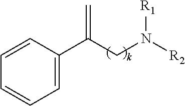

wherein R₁ and R₂ are each independently a hydrocarbyl group or a hydrocarbonaceous group having 1 to 4 additional heteroatoms, such as O, N, S, P, Se, and combinations thereof, or wherein R₁ and R₂ are connected to form a moiety containing at least one 5- to 12-membered ring, from 3 to 24 carbons, and optionally 1 to 6 additional heteroatoms (such as O, N, S, P, Se, and combinations thereof). Monomers with k=2 are preferable due to ease of monomer synthesis and favorable reactivity in the polymerization. Alternatively, monomers with k≥3 may be used, but are more complex to prepare and are less commercially feasible. Alternatively, monomers with k=1 may be used, but are difficult to polymerize via emulsion polymerization.

The functionalized styrenic monomers including a nitrogen-containing moiety, other than as pendant to the phenyl ring, may be co-polymerized with substituted acrylates, methacrylates, acrylamides, methacrylamides, acrylonitriles, methacrylonitriles, 0-vinyl esters, N-vinyl amides, or combinations thereof.

In some embodiments, one or more a polyfunctional comonomers according to structure (V) are included in the polymerization in an amount such that the copolymer forms a crosslinked architecture.

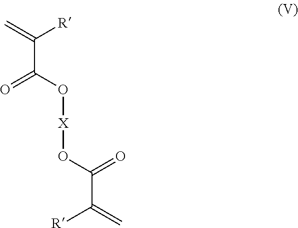

wherein: R′ is a hydrogen or methyl; X is a hydrocarbyl group or a hydrocarbonaceous group having 1 to 20 additional heteroatoms selected from the group consisting of O, N, S, P, Se, and combinations thereof, or wherein X is a hydrocarbyl or hydrocarbonaceous polymer having number-average molecular weight below 10,000 Da and optionally additional heteroatoms selected from the group of O, N, S, P, Se, or a combination thereof.

The inventive functional copolymers disclosed herein based on functionalized styrenic monomers including a nitrogen-containing moiety, other than as pendant to the phenyl ring, and including a polyfunctional comonomer, may be polymerized from the exemplary polyfunctional comonomers according to structure (V), which include ethan-1,2-diyl diacrylate, propan-1,3-diyl diacrylate, butan-1,4-diyl diacrylate, hexan-1,6-diyl diacrylate, octan-1,0-diyl diacrylate, oxybis(ethane-2,1-diyl) diacrylate, (ethane-1,2-diylbis(oxy))bis(ethane-2,1-diyl) diacrylate, ethan-1,2-diyl dimethacrylate, propan-1,3-diyl dimethacrylate, butan-1,4-diyl dimethacrylate, hexan-1,6-diyl dimethacrylate, octan-1,0-diyl dimethacrylate, oxybis(ethane-2,1-diyl) dimethacrylate, (ethane-1,2-diylbis(oxy))bis(ethane-2,1-diyl) dimethacrylate, or combinations thereof, or wherein X in the polyfunctional comonomer of structure (X) is a polymer comprising polyethylene, polypropylene, polyisobutylene, polybutadiene, polyisoprene, polyfarnesene, polystyrene, polyethylene glycol, polypropylene glycol, or combinations thereof.

In some embodiments, the inventive functional polymers disclosed herein based on functionalized styrenic monomers including a nitrogen-containing moiety including a crosslinked polymer architecture may have greater than 20%, or greater than 30%, or greater than 40%, or greater than 50%, or greater 60%, or greater than 70%, or greater than 80%, or greater than 90%, or greater than 95%, of the copolymer crosslinked.

In some embodiments, the polymer within the inventive aqueous based copolymer emulsion compositions disclosed herein utilizing functional polymers based on functionalized styrenic monomers including a nitrogen-containing moiety, other than as pendant to the phenyl ring, may have a number average molecular weight, Mn, of greater than 500 Da, or greater than 1000 Da, or greater than 2000 Da, or greater than 5000 Da, or greater than 10,000 Da. Additionally or alternatively, the inventive aqueous based copolymer emulsion compositions disclosed herein utilizing functional polymers based on functionalized styrenic monomers including a nitrogen-containing moiety, other than as pendant to the phenyl ring, may have a number average molecular weight, Mn, of less than 5,000,000 Da, or less than 3,000,000 Da, or less than 1,000,000 Da, or less than 500,000 Da, or less than 200,000 Da.

In some embodiments, the inventive aqueous based copolymer emulsion compositions disclosed herein utilizing functional polymers based on functionalized styrenic monomers including a nitrogen-containing moiety, other than as pendant to the phenyl ring, may contain greater than 0.01 wt %, or greater than 0.05 wt %, or greater than 0.1 wt %, or greater than 0.5 wt %, or greater than 1.0 wt %, or greater than 5.0 wt %, or greater than 10 wt %, or greater than 20 wt % of repeat units according to structure (II) above.

In some embodiments, the inventive aqueous based copolymer emulsion compositions disclosed herein utilizing functional polymers based on functionalized styrenic monomers including a nitrogen-containing moiety, other than as pendant to the phenyl ring, may contain greater than 0.01 wt %, or greater than 0.05 wt %, or greater than 0.1 wt %, or greater than 0.5 wt %, or greater than 1.0 wt %, or greater than 5.0 wt %, or greater than 10 wt %, or greater than 20 wt % of repeat units according to structure (III) above.

In some embodiments, the inventive aqueous based copolymer emulsion compositions disclosed herein utilizing functional polymers based on functionalized styrenic monomers including a nitrogen-containing moiety, other than as pendant to the phenyl ring, may optionally be further subjected to post-polymerization modification in order to modify their structure.

In some embodiments, the post-polymerization modification is a protonation reaction, wherein one or more amine functional groups are converted to their corresponding ammonium salts by treatment with a protic acid. The protic acid may be any acid which is sufficiently strong to protonate a basic nitrogen atom in the repeat units, and thereby form an ammonium salt of the repeat unit with a counterion corresponding to the conjugate base of the protic acid. Non-limiting examples of the protic acid may include hydrochloric acid, hydrobromic acid, hydroiodic acid, various alkyl or aryl sulfonic acids (i.e. methylsulfonic acid, ethylsulfonic acid, propylsulfonic acid, n-butylsulfonic acid, tert-butylsulfonic acid, benzenesulfonic acid, p-toluenesulfonic acid, p-dodecylbenzenesulfonic acid, and the like), sulfuric acid, phosphoric acid, formic acid, acetic acid, butyric acid, benzoic acid, triflic acid, nitric acid, or a combination thereof, which would yield ammonium salts with respectively chloride, bromide, iodide, alkyl or aryl sulfonate, sulfate, phosphate, formate, acetate, propionate, butyrate, benzoate, triflate, nitrate counterion, or a combination thereof, counterions.

In some embodiments, the post-polymerization modification is an alkylation reaction, wherein one or more amine functional groups within repeat units of structures (II) are converted to their corresponding ammonium salts by treatment with an alkylating agent. Non-limiting examples of alkylating agents may include various alkyl halides (i.e. bromomethane, iodomethane, bromoethane, iodoethane, bromopropane, iodopropane, benzyl chloride, benzyl bromide, benzyl iodide, and the like), various alkyl sulfonates (i.e. methyl tosylate, ethyl tosylate, propyl tosylate, benzyl tosylate, methyl methanesulfonate, ethyl methanesulfonate, propyl methanesulfonate, benzyl methanesulfonate, and the like), various alkyl triflates (i.e. methyl triflate, ethyl triflate, propyl triflate, and the like), or a combination thereof, which would yield ammonium salts with counterions corresponding to the displaced leaving groups of the alkylating agent.

### Methods of Using the Emulsion Composition Based on ADAMS Copolymers

The aqueous based copolymer emulsion compositions disclosed herein utilizing the nitrogen containing copolymers based on anionic polymerization of functionalized styrenic monomers including a nitrogen-containing moiety, other than as pendant to the phenyl ring, may be used for a range of different applications. In particular, the inventive aqueous based copolymer emulsion compositions disclosed herein utilizing functional polymers based on functionalized styrenic monomers including a nitrogen-containing moiety, other than as pendant to the phenyl ring, may be used according to the methods below.

In one embodiment of the method of using the aqueous based copolymer emulsion compositions disclosed herein, the method comprises the steps of:
1) providing a copolymer emulsion composition comprising: i) from 1 to 60 wt. %, or 2 to 50 wt. %, or 4 to 40 wt. %, or 6 to 30 wt. %, or 8 to 25 wt. %, or 10 to 20 wt. %, or 13 to 17 wt. % of one or more copolymers comprising: (a) one or more amine-derivatized alpha-methyl styrene (ADAMS) repeat units according to structure (II):

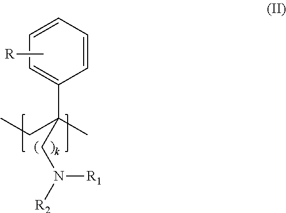

wherein:
   k is an integer from 1 to 3, or k=2;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof; and
   (b) one or more repeat units selected from the group of structures (III):

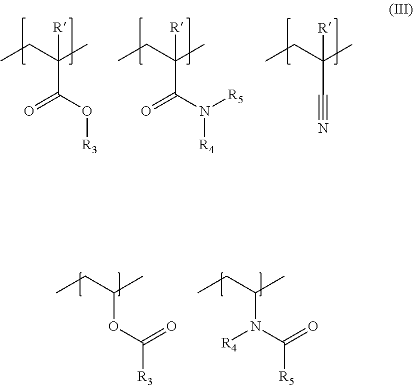

and combinations thereof, wherein:
   R′ is a hydrogen or methyl group;
      R₃, R₄, and R₅ are each independently a hydrogen atom, a hydrocarbyl group having 1 to 30 carbon atoms, or a hydrocarbonaceous group having 1 to 30 carbon atoms and 1 to 6 additional heteroatoms selected from the group consisting of O, N, S, P, Si, and combinations thereof, or
      wherein R₃ is a hydrocarbyl or hydrocarbonaceous polymer having number-average molecular weight below 10,000 Da and optionally additional heteroatoms selected from the group of O, N, S, P, Se, or a combination thereof, or
      wherein R₄ and R₅ are connected to form a moiety containing at least one 5- to 12-membered ring, from 3 to 30 carbon atoms, and optionally 1 to 6 additional heteroatoms selected from the group consisting of O, N, S, P, Si, or a combination thereof; and
   ii) from 0.05 to 5.0 wt. %, or 0.1 to 4.5 wt. %, or 0.5 to 4.0 wt. %, or 1.0 to 3.5 wt. %, or 1.5 to 3.0 wt. %, or 2.0 to 2.5 wt. % of one or more one or more surfactants selected from the group consisting of anionic surfactants, cationic surfactants, nonionic surfactants, amphoteric surfactants, and combinations thereof;
   iii) the remainder of the composition comprising water; and
2) using the emulsion composition or an additive mixture including the emulsion composition in an application selected from the group consisting of a secondary metal ion battery additive, a plastic additive, a drag reducing agent, a magneto-rheological fluid, an electro-chlorination additive, an industrial coating additive, an adhesive additive, an asphaltene and wax inhibitor, a refinery anti-foulant, an industrial or household surfactant, an agrochemical additive, a ceramic capacitor or indictor additive, an emulsion explosive additive, an anti-microbial coating, a crude transportation and refining additive, and a carbon-capture additive. One particularly preferred application of the aqueous based copolymer emulsion compositions disclosed herein is as a secondary metal ion battery additive, and more particularly as a secondary metal ion battery slurry composition for coating the battery anode or cathode.

In another embodiment of the method of using the aqueous based copolymer emulsion compositions disclosed herein comprises the steps of:
1) providing a copolymer emulsion composition comprising: i) from 1 to 60 wt. %, or 2 to 50 wt. %, or 4 to 40 wt. %, or 6 to 30 wt. %, or 8 to 25 wt. %, or 10 to 20 wt. %, or 13 to 17 wt. % of one or more copolymers comprising:
   (a) the reaction product of one or more monomers according to structure (I)

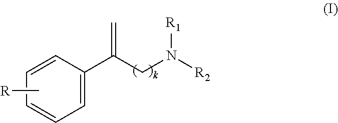

wherein:
   k is an integer from 1 to 3; or k=2;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof; and
   (b) the reaction product of one or more monomers selected from the group consisting of optionally substituted acrylates, methacrylates, acrylamides, methacrylamides, acrylonitriles, methacrylonitriles, 0-vinyl esters, N-vinyl amides, or combinations thereof;
   (ii) 0.05 to 5.0 wt. %, or 0.1 to 4.5 wt. %, or 0.5 to 4.0 wt. %, or 1.0 to 3.5 wt. %, or 1.5 to 3.0 wt. %, or 2.0 to 2.5 wt. % of one or more one or more surfactants selected from the group consisting of anionic surfactants, cationic surfactants, nonionic surfactants, amphoteric surfactants, and combinations thereof;
   (iii) the remainder of the composition comprising water; and
2) using the emulsion composition or an additive mixture including the emulsion in an application selected from the group consisting of a secondary metal ion battery additive, a plastic additive, a drag reducing agent, a magneto-rheological fluid, an electro-chlorination additive, an industrial coating additive, an adhesive additive, an asphaltene and wax inhibitor, a refinery anti-foulant, an industrial or household surfactant, an agrochemical additive, a ceramic capacitor or indictor additive, an emulsion explosive additive, an anti-microbial coating, a crude transportation and refining additive, and a carbon-capture additive. One particularly preferred application of this embodiment of the aqueous based copolymer emulsion composition is as a secondary metal ion battery additive, and more particularly as a secondary metal ion battery slurry composition for coating the battery anode or cathode.

### Methods of Making the Emulsion Composition Based on ADAMS Copolymers

The novel copolymers of functionalized styrenic monomers including a nitrogen-containing moiety, other than as pendant to the phenyl ring, or of functionalized conjugated (non-aromatic) monomers including a nitrogen-containing moiety, may be made by free radical or controlled radical polymerization techniques such as RAFT (Reversible Addition Fragmentation Chain Transfer) in emulsion polymerization. Customary free-radical polymerization is explained, inter alia, in Ullmanns's Encyclopedia of Industrial Chemistry, Sixth Edition. Customary emulsion polymerization is explained, inter alia, in Emulsion Polymerization in Encyclopedia of Polymer Science and Engineering (2009).

The inventive radical polymerization via aqueous emulsion polymerization processes disclosed herein generally comprise at least the following steps:
(a) preparing one or more monomer emulsion mixtures by combining one or more radically polymerizable monomers, with one or more emulsifiers (surfactants) in water, optionally with one or more pH buffers, optionally with one or more reaction modifiers, preferably maintained under an inert (typically N2 or Ar) atmosphere;
(b) preparing a polymerization reaction mixture by combining water, optionally with one or more emulsifiers (surfactants), optionally with one or more pH buffers, optionally with one or more a pre-formed seed latex (polymer dispersion) from a different emulsion polymerization or emulsification, preferably maintained under an inert (typically N2 or Ar) atmosphere;
(c) adding the one or more monomer emulsion mixtures, in a continuous or discontinuous manner, to the polymerization reaction mixture over some or all of the reaction duration;
(d) adding one or more radical initiators, or a solution thereof, in a continuous or discontinuous manner, to the polymerization reaction mixture over some of all of the reaction duration;
(e) heating or cooling the polymerization mixture to a sufficient temperature, and for a sufficient time, such that radical initiation and polymerization reactions occur. A sufficient time may be at least 30 minutes, or at least 60 minutes, or at least 90 minutes, or at least 120 minutes, or at least 240 minutes, or at least 360 minutes or at least 1,440 minutes. Depending on the specific radical initiator or combination used, the reaction temperature may be from 0 to 120° C., or from 5 to 100° C., or from 10 to 90° C., or from 20 to 85° C., or from 30 to 80° C., or from 40 to 75° C. The reaction temperature may also be changed over the course of the reaction within the above ranges;
(f) optionally adding a suitable red/ox initiator system as a post-polymerization treatment.

Of the one or more monomer emulsion mixtures used to prepare the inventive aqueous based amine containing copolymer emulsion compositions disclosed herein, based on the functionalized styrenic monomers including a nitrogen-containing moiety other than as pendant to the phenyl ring, at least one monomer emulsion mixture must comprise a radically polymerizable monomer according to structure (I):

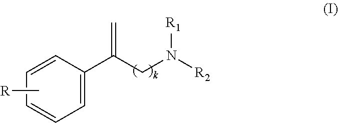

wherein:
k is an integer from 1 to 3; or k=2;
R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof.

Of the one or more monomer emulsion mixtures used to prepare the inventive aqueous based amine containing copolymer emulsion compositions disclosed herein, based on the functionalized styrenic monomers including a nitrogen-containing moiety other than as pendant to the phenyl ring, at least one monomer emulsion mixture must comprise a radically polymerizable monomer selected from the group consisting of optionally substituted acrylates, methacrylates, acrylamides, methacrylamides, acrylonitriles, methacrylonitriles, 0-vinyl esters, N-vinyl amides, or combinations thereof.

The polymer content of the final aqueous polymer dispersion may be in the range of 10 to 60 wt % by, or 20 to 50 wt %, or 30 to 40 wt %.

### Surfactants/Emulsifiers

Surfactants may also be referred to as emulsifiers or emulsifying agents herein and are used to disperse the one or more copolymers in the aqueous phase of the emulsion. The surfactants used herein are not particularly limited, and may include, for example, fatty acid soaps and rosin soaps. As specific examples of the fatty acid soaps, there can be sodium salts and potassium salts of a long chain fatty acid having 12 to 18 carbon atoms, such as lauric acid, myristic acid, palmitic acid, stearic acid, oleic acid or a mixed fatty acid thereof. As specific examples of the rosin soaps, there can be sodium salts and potassium salts of a disproportionated or hydrogenated product of natural rosin, such as gum rosin, wood rosin or tall oil rosin.

The surfactants used in the copolymer emulsion compositions disclosed herein may be classified as ionic, or non-ionic, and are preferably water soluble. Ionic surfactants or emulsifiers used herein may be anionic, cationic, or combinations thereof. A wide variety of surfactants may be used as emulsifying agents herein, including anionic surfactants, cationic surfactants, nonionic surfactants, amphoteric surfactants, and combinations thereof.

The total amount of surfactant in the monomeric composition may be from 0.01 to 5%, in particular from 0.1 to 2%, more particularly from 0.2 to 1.5%, by weight of surfactant based on the total weight of the radically polymerizable monomers.

Preferred water-soluble emulsifiers are ionic surfactants or ionic emulsifiers. Anionic surfactants that may be used in in the copolymer emulsion compositions disclosed herein, may include alkali or ammonium soaps of resin acids and/or fatty acids, for instance of oleic acid, palmitic acid, stearic acid, lauric acid, myristic acid, arachic acid, ricinic acid. Other suitable anionic type surfactants are the alkali or ammonium soaps of branched carboxylic acids, of alkyl or arylsulphuric acids, of alky or arylsulphonic acids, as well as of sulphated or sulphonated glycidyl esters of carboxylic acids. Other examples of anionic surfactants or emulsifiers for use in the styrene-diene polymer emulsion compositions disclosed herein include, but are not limited to, anionic surface active agents such as higher alcohol sulfate esters, alkylbenzenesulfonate salts, aliphatic sulfonate salts, polyoxyethylene alkylarylsulfonate salts and polyphosphate salts. Other non-limiting exemplary anionic surfactants include soaps, turkey red oil, emulsifying oils, alkyl naphthalene sulfonates, dodecylbenzene sulfonate, oleate salts, alkylbenzene sulfonates, dialkyl sulfosuccinates, lignine sulfonate, alcohol ethoxysulfates, secondary alkanesulfonates, alpha-olefinsulfonic acids, and Tamol™. Still other exemplary anionic surfactants include fatty acids, e.g., myristic acid, palmitic acid, oleic acid, rinoleic acid, and salts thereof, alkylarylsulfonic acid salts, sulfuric acid esters of higher alcohols, alkyl sulfosuccinates, and combinations thereof.

Still further other exemplary anionic surfactants are alkyl aryl sulfonates such as dodecyl benzene sodium sulfonate, dodecyl phenyl ether sodium sulfonate or the like; sulfosuccinate such as dioctyl sodium sulfosuccinate, dihexyl sodium sulfosuccinate or the like; salt of fatty acid such as sodium laurate or the like; ethoxy sulfate such as polyoxyethylene lauryl ether sodium sulfate or the like; alkane sulfonate; and alkyl ether sodium phosphate or the like.

Cationic surfactants that may be used in the copolymer emulsion compositions disclosed herein, may include aliphatic amine salts and quaternary ammonium salts thereof, aromatic quaternary ammonium salts, heterocyclic quaternary ammonium salts, and combinations thereof. Other, non-limiting exemplary cationic surfactants may include alkyl trimethyl ammonium salts, dialkyl dimethyl ammonium salts, alkyl pyrizinium salts, and alkyl benzyl dimethyl ammonium salts. Still other exemplary cationic surfactants may include trimethyl ammonium chloride, dialkylammonium chloride, benzylammonium salt, quaternary ammonium salts, and combinations thereof.

Non-ionic surfactants that may be used in copolymer emulsion compositions disclosed herein, include, but are not limited to, polyoxyethylene alkyl ethers, polyoxyethylene alkyl aryl ethers, polyoxyethylene fatty acid esters, polyoxyethylene sorbitan fatty acid esters, polyoxyethylene oxypropylene block polymers, akylsulfinyl alcohols, fatty acid monoglycerides, and combinations thereof. Other exemplary non-ionic surfactants include polyoxyethylene alkyl ether, polyoxyethylene alkylphenol ether, polyoxyethylene alkyl ester, and polyoxyethylene sorbitan alkyl ester. The non-ionic surfactant is advantageously a polyoxyethyelen alkyl ether such as polyoxyethylene lauryl ether, polyoxyethylene cetyl ether, polyoxyetheylen stearyl ether or polyoxyethylene oleyl ether; polyoxyethylene alkyl aryl ether such as polyoxyethylene nonyl phenyl ether or polyoxyethylene octyl phenyl ether; polyethylene glycol fatty acid ester, polyethylene glycol phosphate; sorbitol fatty acid ester; fatty acid monoglyceride; polyglycerine fatty acid ester; propyleneglycol fatty acid ester; cane sugar fatty acid ester, polyoxyethylene-polyoxypropylene block copolymer; polyoxyethylene-polyoxypropylene alkyl ether; ethylene oxide derivative of alkyl phenol formalin condensate; polyoxyethylene glycerine fatty acid ester, polyoxyethylene hardened castor oil; polyoxyethylene sorbitol fatty acid ester; fatty acid alkanolamide; polyoxyethylene fatty acid amide; and combinations thereof. The nonionic surfactant disclosed herein may be alternatively used with a water soluble polymer, such as, for example, polyethylene oxide (PEO), polyvinyl alcohol (PVA), carboxymethyl cellulose, polyacrylic acid, and combinations thereof.

Amphoteric surfactants that may be used in the copolymer emulsion compositions disclosed herein, may include, for example, carboxybetaine, sulfobetaine, aminocarboxylate salts, imidazoline derivatives, alkyl betaines, alkyl diethylenetriaminoacetates, and combinations thereof.

In some embodiments, the optional one or more pH buffers are aqueous solutions comprising lithium, sodium, potassium, ammonium, or pyridinium salts of carbonate, bicarbonate, hydroxide, formate, acetate, phosphate, borate, sulfonate anions, or combinations thereof. pH buffers comprising sodium bicarbonate, sodium carbonate, or sodium hydroxide, or combinations thereof, are preferred.

The monomeric composition may comprise 0 to 0.5%, in particular 0.01 to 0.25%, by weight of buffer based on the total weight of the radically polymerizable monomers.

### Reaction Modifiers

In some embodiments the one or more chain transfer agents (CTA), can be optionally added to the polymerization reaction. Chain transfer agents include mercapto compounds such as t-dodecyl mercaptan, dialkyl sulfides, dialkyl disulfides and/or diaryl sulfides, such as di-n-butyl sulfide, di-n-octyl sulfide, diphenyl sulfide, thiodiglycol, ethylthioethanol, diisopropyl disulfide, di-n-butyl disulfide, di-n-hexyl disulfide, diacetyl disulfide, diethanol disulfide, di-tert-butyl trisulfide and dimethyl sulfoxide, ethyl thioglycolate, 2-ethylhexyl thioglycolate, cysteine, 2-mercaptoethanol, 3-mercaptopropanol, 3-mercaptopropan-1,2-diol, 1,4-mercaptobutanol, mercaptoacetic acid, 3-mercaptopropionic acid, mercaptosuccinic acid, thioglycerol, thioacetic acid, thiourea, n-butyl mercaptan, n-hexyl mercaptan, n-dodecyl mercaptan, dimeric alpha-methylstyrene, (2,4-diphenyl-4-methyl-1-pentene), enol ethers of aliphatic and/or cycloaliphatic aldehydes, terpenes, beta-terpinene, terpinolene, 1,4-cyclohexadiene, 1,4-dihydronaphthalene, 1,4,5,8-tertrahydronapthalene, 2,5-dihydrofuran, 2,5-dimethylfuran and/or 3,6-dihydro-2H-pyran, or combinations thereof. The monomeric composition may comprise from 0 to 0.2%, from 0 to 0.15%, from 0 to 0.1%, from 0 to 0.05%, from 0 to 0.02%, from 0 to 0.01%, from 0 to 0.005%, from 0 to 0.002%, from 0 to 0.001%, or even 0%, by weight of chain transfer agent based on the total weight of the radically polymerizable monomers.

### Initiators

In some embodiments one or more radical initiators are water soluble initiators. Such initiators are well known in the art and include inorganic persulfate compounds such as ammonium persulfate, potassium persulfate, or sodium persulfate; hydrogen peroxide; organic hydroperoxides such as cumene hydroperoxide, t-butyl hydroperoxide, acetyl peroxide, benzoyl peroxide, lauroyl peroxide; peracetic acid and perbenzoic acid; redox systems comprising a peroxide and a reducing agent (such as ferrous compounds, carboxylic acids, sodium metabisulfite, or sodium formaldehyde sulfoxylate), which promote the decomposition of the peroxide; as well as other free radical producing materials such as an azo-initiator, for example 2,2′-azobisisobutyronitrile, 4,4′-azobis(4-cyanovaleric acid) or 2,2′-azobis(2-methylbutyronitrile); and combinations thereof.

The total amount of initiator in the monomeric composition may be from 0.01 to 3.0%, or 0.1 to 2.0%, or 0.2 to 1.5%, by weight of initiator based on the total weight of the radically polymerizable monomers.

### Post-Polymerization Treatment

A specific redox system may be used as post-polymerization treatment to advantageously reduce the residual monomer content of the final aqueous polymer dispersion. Such redox system comprises a peroxide and one or more reducing agents such as ferrous compounds, carboxylic acids, sodium metabisulfite, or sodium formaldehyde sulfoxylate, which promote the decomposition of the peroxide. The redox system may represent from 0.1 to 2% by weight, relative to the total weight of the radically polymerizable monomers and may be conducted directly after the emulsion polymerization with or without cooling the emulsion polymerization medium, at a temperature of at least 25° C., 30° C., 40° C., at least 50° C., at least 60° C., or at least 70°.

### Process for the Preparation of the Polymer Emulsion Composition

The emulsion polymerization may be conducted using any known emulsion polymerization procedure which produces polymer dispersions in aqueous latex form. Such procedures, such as conventional batch and semi-continuous emulsion polymerization processes, are described in, for example, Emulsion Polymerization in Encyclopedia of Polymer Science and Engineering (2009).

The emulsion polymerization may be conducted using the following conditions. A monomer-emulsion mixture comprising one or more radically polymerizable monomers, with one or more emulsifiers (surfactant), optionally with one or more pH buffers, optionally with one or more reaction modifiers in deionized water may be prepared. A solution of one or more initiators in deionized water may be separately prepared. The monomer emulsion mixture and the initiator solution may be fed in a reactor.

The introduction of the monomer emulsion mixture may be continuous, for example over a time of at least 30 minutes, or at least 60 minutes, or at least 90 minutes, or at least 120 minutes, or at least 240 minutes, or at least 360 minutes. Alternatively, the introduction of the monomer emulsion mixture may be discontinuous, for example, the monomer emulsion bay be completely fed into the reaction at the start, or part of the monomer emulsion mixture may first be introduced in the reactor to form seed particles and the remainder of the monomer emulsion mixture may be introduced in one or more successive steps. The radically polymerizable monomers in the initial ‘seed’ part of the monomer emulsion mixture may represent from 0.05 to 10% by weight of the total weight of radically polymerizable monomers. Alternatively, a pre-formed seed latex (polymer dispersion) from a different emulsion polymerization or emulsification may be used and the monomer emulsion mixture may be then introduced in one or more successive steps. The emulsion polymerization may be a multistage emulsion polymerization with at least two successive steps of polymerization using different monomeric compositions.

The introduction of the initiator solution depends on the chemical nature of the initiator system and the kind of polymerization process. The initiator solution can be introduced in the reactor continuously or stepwise in the course of the emulsion polymerization. Normally, it is preferred to introduce part of the initiator solution in the reaction in a first step and then feeding the remainder into the reactor according to the monomers feed.

The polymerization reaction can be heated or cooled to a sufficient temperature for the one or more radical initiator to generate reactive radicals in the mixture. Depending on the specific radical initiator or combination used, the reaction temperature may be from 0 to 120° C., or from 5 to 100° C., or from 10 to 90° C., or from 20 to 85° C., or from 30 to 80° C., or from 40 to 75° C. The reaction temperature may also be changed over the course of the reaction within the above ranges.

The post-polymerization treatment, comprising of adding a suitable red/ox initiator system as described above, may be conducted directly after the emulsion polymerization. Depending on the specific red/ox initiator system, the post-polymerization treatment may be conducted with or without cooling the emulsion polymerization medium, at a temperature of at least 25° C., 30° C., 40° C., at least 50° C., at least 60° C., or at least 70° C.

The polymerization reaction is run for a sufficient time that at least 20 wt %, or at least 40 wt %, or at least 60 wt %, or at least 80 wt %, or at least 90 wt %, or at least 95 wt %, or at least 98 wt % of the one or more radically polymerizable monomers have polymerized via gravimetric analysis.

The inventive monomers disclosed in U.S. Provisional Application Ser. No. 63/483,365 have, to the best of the Applicant's knowledge, not been previously polymerized.

### Secondary Battery Electrode Slurry Compositions

Also provided herein are electrode slurry compositions for use in a secondary metal ion battery composition. The electrode slurry composition includes the aqueous based copolymer emulsion composition disclosed above and additionally includes one or more co-binders, one or more conductive carbon-based particles, and one or more of silicon based particles. The one or more conductive carbon-based particles may be selected from the group consisting of carbon nanotubes, graphite, and combinations thereof. The one or more of silicon based particles may be selected from the group consisting of silicon particles, silicon alloy particles, silica particles or combinations thereof.

The electrode slurry compositions for use in a secondary metal ion battery composition disclosed herein may improve the life of the secondary metal ion battery, but at least 1%, or at least 2%, or at least 3%, or at least 4%, or at least 5%, or at least 7%, or at least 10%, or at least 15%, or at least 20%. The electrode slurry compositions for use in a secondary metal ion battery composition disclosed herein may also improve the charge capacity retention of the secondary metal ion battery, but at least 1%, or at least 2%, or at least 3%, or at least 4%, or at least 5%, or at least 7%, or at least 10%, or at least 15%, or at least 20%.

### Co-Binders for Slurry Compositions

The electrode slurry compositions for use in a secondary metal ion battery composition disclosed herein include one or more co-binders. Non-limiting exemplary co-binders include polyacrylic acid (PAA), carboxymethyl cellulose (CMC), sodium alginate (SA), polyvinyl alcohol (PVA), chitosan (CS), polyacrylonitrile (PAN), polyimide (PI), gum arabic (GA), guar gum (GG), and combinations thereof. Other non-limiting exemplary co-binders include alginic acid and their various salts. Still other non-limiting exemplary co-binders include carboxy methyl cellulose (CMC)-based binders and its various salts (including but not limited to Na-CMC, Li-CMC, K-CMC, etc. and their mixtures may also be used as co-binders herein. In some designs, Li-salt of CMC may often be particularly favorable, and more particularly including those that additionally comprise elastic polymer nanoparticles, such as styrene butadiene rubber (SBR); polyacrylic acid (PAA) and their various salts (including but not limited to Na-PAA, Li-PAA, K-PAA, Ca-PAA and others and their mixtures. In some forms, Li-PAA salt may often be particularly favorable); (poly)alginic acid and various salts of (poly)alginic acid (Na-alginate, Li-alginate, Ca-alginate, K-alginate and many others and their various mixtures. In some forms, Li-alginate salt may often be particularly favorable) as well as maleic acid and their various salts (e.g., Li, Na, K, etc.). In other forms, Li-salt may often be particularly favorable), various (poly)acrylates (including, but not limited to dimethylaminoethyl acrylate and many others), various (poly)acrylamides, various polyesters, styrene butadiene rubber (SBR), (poly)ethylene oxide (PEO), (poly)vinyl alcohol (PVA), cyclodextrin, maleic anhydride, methacrylic acid and its various salts (Li, Na, K, etc.). In yet other forms, Li-salt may often be particularly favorable) as well as various (poly)ethylenimines (PEI), various (poly)amide imides (PAI), various (poly)amide amines, various other polyamine-based polymers, various (poly)ethyleneimines, sulfonic acid and their various salts, various catechol group-comprising polymers, various lignin-comprising or lignin-derived polymers, various epoxies, various cellulose-derived polymers (including, but not limited to nanocellulose fibers and nanocrystals, carboxyethyl cellulose, etc.), chitosan, other polymers (e.g., preferably water-soluble polymers) and their various co-polymers and mixtures thereof.

### Anode Active Materials (Carbon Based and Silicon Based Materials)

The electrode slurry compositions for use in a secondary metal ion battery composition disclosed herein include one or more active materials, such as for example, anode active materials. Active materials include carbon based active materials or particles, silicon based active materials or particles, and combinations thereof.

In one form, the electrode slurry compositions for use in a secondary metal ion battery composition disclosed herein include various carbon based active materials and/or silicon based active materials including, but not limited to, graphite, silicon, silicon oxide, silicon-graphene, silicon-aluminum alloy, tin/graphene, and various polymer binders (described above). Exemplary carbon based active materials include graphite, carbon nanotubes, and combinations thereof. In one form, the carbon based active material may have particle sizes of greater than equal to 10 μm, or greater than equal to 15 μm, or greater than equal to 20 μm, or greater than equal to 25 μm, or greater than equal to 30 μm, or greater than equal to 35 μm, or greater than equal to 40 μm, or greater than equal to 45 μm, or greater than equal to 50 μm. In another form, the carbon based active material may have particle sizes of less than equal to 10 μm, or less than equal to 8 μm, or less than equal to 6 μm, or less than equal to 4 μm, or less than equal to 2 μm, or less than equal to 1 μm, or less than equal to 0.5 μm. In yet another form, the carbon based active material may include a first carbon based active material, such as graphite, having particle sizes of more than about 10 μm, and a second carbon based active materials, such as graphite, having particles sizes of less than about 10 μm.

Exemplary silicon based active materials include silicon particles, silicon alloy particles, silica particles or combinations thereof. Silicon based materials may also include nanoparticles, nanowire and silicon/graphene composites. Silicon nanoparticle and nanowire anodes are expected to benefit from a fairly high binder loading (less than 15 wt %) and solvent in a wet electrode coating process because of the high surface area of these materials. One particularly advantageous anode active material for use in anodes is a combination of silicon and graphite to form a silicon/graphite composite. In another form, the silicon based active material may have particle sizes of greater than equal to 10 nm, or greater than equal to 15 nm, or greater than equal to 20 nm, or greater than equal to 25 nm, or greater than equal to 30 nm, or greater than equal to 35 nm, or greater than equal to 40 nm, or greater than equal to 45 nm, or greater than equal to 50 nm, or greater than equal to 60 nm, or greater than equal to 70 nm, or greater than equal to 80 nm, or greater than equal to 90 nm, or greater than equal to 100 nm, or greater than equal to 120 nm, or greater than equal to 140 nm, or greater than equal to 160 nm, or greater than equal to 180 nm, or greater than equal to 200 nm. In another form, the silicon based active material may have particle sizes of greater than equal to 100 μm, or greater than equal to 150 μm, or greater than equal to 200 μm, or greater than equal to 250 μm, or greater than equal to 300 μm, or greater than equal to 350 μm, or greater than equal to 400 μm, or greater than equal to 450 μm, or greater than equal to 500 μm.

The active materials and methods described herein may offer an advantage at higher silicon content in a composite anode electrode film, and may provide high energy density electrodes. A dry anode electrode film including a silicon/graphite composite anode active material as described herein may deliver electrochemical charge capacity comparable to its theoretical charge capacity. Thus, the silicon active materials in a dry silicon/graphite composite anode electrode film may be electrochemically active and accessible over a charge/discharge cycle.

### Method of Making Electrode Slurry Compositions

Also disclosed herein are methods of making an electrode slurry composition for a secondary metal ion battery, which includes the steps of: i. dispersing into an aqueous solution one or more conductive carbon-based particles, and one or more of silicon based particles; ii. mixing into the aqueous solution an aqueous based copolymer emulsion composition as described above; and iii. further mixing into the aqueous solution one or more co-binders to form the electrode slurry composition. As described above, the one or more conductive carbon-based particles may include, but are not limited to, of carbon nanotubes, graphites; and combinations thereof. Other conductive carbon-based particles as described above may also be utilized. As described above, the one more co-binders may include, but are not limited to, polyacrylic acid, carboxymethyl cellulose, hydroxyethyl cellulose, polyvinyl alcohol, polyurethane. Other co-binders as described above may also be utilized.

### Secondary Metal Ion Battery Anodes

Also disclosed herein are secondary metal ion battery anodes that include a copper foil substrate having a thickness of from 5 to 50 microns, or 10 to 45 microns; or 15 to 40 microns, or 20 to 35 microns, or 25 to 30 microns. The secondary metal ion battery anodes also include a continuous coating layer having a thickness of from 50 to 500 microns, or 100 to 450 microns; or 150 to 400 microns, or 200 to 350 microns, or 250 to 300 microns on one surface of the copper foil substrate.

The continuous coating layer includes from 10 to 80 wt. %, or 15 to 75 wt. %, or 20 to 70 wt. %, or 25 to 65 wt. %, or 30 to 60 wt. %, or 35 to 55 wt. %, or 40 to 50 wt. % of one or more conductive carbon-based particles; from 1 to 80 wt. %, or 5 to 75 wt. %, or 10 to 70 wt. %, 15 to 65 wt. %, or 20 to 60 wt. %, or 25 to 55 wt. %, or 30 to 50 wt. %, or 35 to 45 wt. % of one or more of silicon based particles; from 1 to 10 wt. %, or 2 to 8 wt. %, or 4 to 6 wt. % of one or more copolymer binders comprising an aqueous based copolymer emulsion composition, comprising:
i) from 1 to 60 wt. % of one or more copolymers comprising:
(a) one or more amine-derivatized alpha-methyl styrene (ADAMS) repeat units according to structure (II):

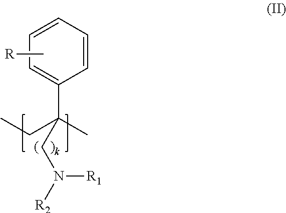

wherein: k is an integer from 1 to 3;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof;
(b) one or more repeat units selected from the group of structures (III):

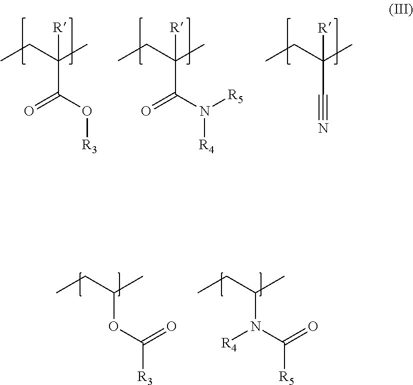

and combinations thereof, wherein:
   R′ is a hydrogen or methyl group;
   R₃, R₄, and R₅ are each independently a hydrogen atom, a hydrocarbyl group having 1 to 30 carbon atoms, or a hydrocarbonaceous group having 1 to 30 carbon atoms and 1 to 6 additional heteroatoms selected from the group consisting of O, N, S, P, Si, and combinations thereof, or
   wherein R₃ is a hydrocarbyl or hydrocarbonaceous polymer having number-average molecular weight below 10,000 Da and optionally additional heteroatoms selected from the group of O, N, S, P, Se, or a combination thereof, or
   wherein R₄ and R₅ are connected to form a moiety containing at least one 5- to 12-membered ring, from 3 to 30 carbon atoms, and optionally 1 to 6 additional heteroatoms selected from the group consisting of O, N, S, P, Si, or a combination thereof; and
(ii) from 0.05 to 5.0 wt. % of one or more one or more surfactants selected from the group consisting of anionic surfactants, cationic surfactants, nonionic surfactants, amphoteric surfactants, and combinations thereof; and
(iii) the remainder of the composition comprising water.

Alternatively, the continuous coating layer includes from 10 to 80 wt. %, or 15 to 75 wt. %, or 20 to 70 wt. %, or 25 to 65 wt. %, or 30 to 60 wt. %, or 35 to 55 wt. %, or 40 to 50 wt. % of one or more conductive carbon-based particles; from 1 to 80 wt. %, or 5 to 75 wt. %, or 10 to 70 wt. %, 15 to 65 wt. %, or 20 to 60 wt. %, or 25 to 55 wt. %, or 30 to 50 wt. %, or 35 to 45 wt. % of one or more of silicon based particles; from 1 to 10 wt. %, or 2 to 8 wt. %, or 4 to 6 wt. % of one or more copolymer binders comprising: an aqueous based copolymer emulsion composition, comprising: i) from 1 to 60 wt. % of one or more copolymers comprising:
(a) the reaction product of one or more monomers according to structure (I)

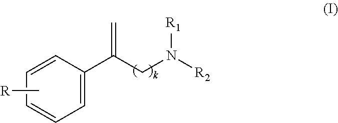

wherein: k is an integer from 1 to 3; R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof; and
(b) the reaction product of one or more monomers selected from the group consisting of optionally substituted acrylates, methacrylates, acrylamides, methacrylamides, acrylonitriles, methacrylonitriles, 0-vinyl esters, N-vinyl amides, or combinations thereof;
(ii) from 0.05 to 5.0 wt. % of one or more surfactants selected from the group consisting of anionic surfactants, cationic surfactants, nonionic surfactants, amphoteric surfactants, and combinations thereof; and
(iii) the remainder of the composition comprising water.

The secondary metal ion battery anodes disclosed herein also include in the continuous coating layer described above from 0 to 10 wt. %, or 1 to 8 wt. %, or 2 to 6 wt. % for 3 to 5 wt. % of one or more co-binders. As described above, the one or more conductive carbon-based particles may include, but are not limited to, of carbon nanotubes, graphites; and combinations thereof. Other conductive carbon-based particles as described above may also be utilized in the continuous coating layer of the anodes. As described above, the one more co-binders may include, but are not limited to, polyacrylic acid, carboxymethyl cellulose, hydroxyethyl cellulose, polyvinyl alcohol, polyurethane. Other co-binders as described above may also be utilized in the continuous coating layer of the anodes.

### Test Methods

Properties indicated in the Examples and the methods by which they are measured are as follows:

Gel permeation chromatography (GPC) samples were prepared on 3.0-5.0 ml scale by dissolving a sample of either the crude reaction mixture or the isolated polymer product, in stabilized tetrahydrofuran (THF) targeting a final sample concentration between 1.0-5.0 g polymer/ml THF. Samples were filtered through a PALL ACRODISC 0.45 μm wwPTFE filter, before being analyzed.

GPC was run using an AGILENT 1260 INFINITY II system, equipped with an AGILENT 1260 refractive index detector, and three AGILENT PLGEL 10 μm mixed-B chromatography columns maintained at 35° C. by the GPC column heater. Samples were run using a 50 μL injection volume, using stabilized THF (1.0 ml/min, isocratic) as the mobile phase, and a 45.0 min experiment run time.

GPC data analysis used AGILENT CIRUS GPC/SEC software, version 3.4.2.

The GPC was calibrated using WATERS ACQUITY APC polystyrene (PS) test kit standards between Mn=266-1,760,000 Da. All polymer Mn, Mw, Mz values are reported vs. PS standard, unless specified otherwise.

To prepare the NMR samples, ˜50-100 mg of the crude reaction mixture was added to a vial followed by 400 μL of benzene-d₆. The vial was sealed, mixed thoroughly until the sample had fully dissolved, and then transferred to an NMR tube. ¹H NMR spectra (16 scans) were recorded at 300 MHz with Bruker AVANCE™-300 instruments. Samples were prepared in benzene-d₆ and chemical shifts (6) are quoted in parts per million (ppm), referenced to TMS contained in the NMR solvent or, preferably, to the benzene-d₆ solvent peak calibrating the solvent singlet to 7.16 ppm.

Dynamic Light Scattering (DLS) measurements were used to measure the average size of the copolymer particles in the finished aqueous-based copolymer emulsions. Measurements were conducted on a WYATT DYNA-PRO NANOSTAR laser photometer, and analyses with WYATT DYNAMICS control software ver. 7.8.2.18. DLS samples were prepared by diluting the copolymer emulsion solutions prepared in Emulsion Examples 1-27 with distilled water to 100:1 relative to the finished copolymer emulsion solution, then filtering the diluted solutions through a PALL ACRODISC 0.45 μm wwPTFE filter. The particle sizes reported below are the are the average result of the cumulant fit of 6× acquisitions per sample.

Electrical conductivity of the aqueous based polymer emulsion composition is measured by ASTM F1529-02.

This disclosure will be further understood by reference to the following (non-limiting) examples. In the Examples, all parts are parts by weight, unless otherwise noted.

### EXAMPLES

### Example 1. Preparation of Aqueous Dispersion of Linear Polymer Derived from N,N-dimethyl-3-phenylbut-3-en-1-amine with butyl acrylate and 2-ethylhexyl acrylate

(1) To a 1000 mL jacketed glass reactor equipped with overhead stirrer (dual impellers), reflux condenser, N2 blanket, and PTFE feed lines, was added deionized water and sodium dodecyl sulfate (Initial Charge). The reactor was heated to 88° C. under N₂.
(2) To a 1000 mL glass reactor equipped with overhead stirrer and N₂ blanket were added deionized water (152.5 g), sodium dodecylsulfate (SDS) (0.925 g), 5 wt % sodium hydroxide solution (10 g), and the monomer mixture comprising of N,N-dimethyl-3-phenylbut-3-en-1-amine (25 g), n-butyl acrylate (50 g), and 2-ethylhexyl acrylate (175 g). The reactor was then mixed at 400-500 rpm for at least 15 minutes to achieve a stable monomer emulsion.
(3) Two initiator solutions were prepared: (1) reactor initiator containing 0.292 g sodium persulfate in 5 g deionized water; and (2) feed initiator containing 0.875 g sodium persulfate in 11.1 g deionized water.
(4) When the initial charge mixture reached the required temperature, 2.5 wt % of the monomer emulsion (10.3 g) and the full volume of the reactor initiator solution were added.
(5) The reaction was held at 88° C. for 10 min, after which the monomer emulsion and feed initiator solution were fed to the reactor over ˜3 hours per the table below. After the additions were complete, the reaction was held at 88° C. for 1 hour.
(6) Then the temperature was cooled to 70-C and 0.83 g of iron sulfate was added to the reactor. Then 10.5 g of TBPH aqueous solution and consecutively 10.5 g of sodium formaldehyde sulfoxylate aqueous solution were fed at a constant rate in 20 min.
(7) The resulting reaction mixture was cooled and filtered through cheese cloth. The solid content was ˜27 wt %.

| | | Amount | wt % vs. total |
|---|---|---|---|
| | | (g) | monomers |
| Initial | Deionized water | 500 | 200 |
| charge | Sodium dodecylsulfate | 1.575 | 0.63 |
| Monomer | Deionized water | 152.5 | 65 |
| Emulsion | Sodium dodecylsulfate | 0.925 | 0.37 |
| | N,N-dimethyl-3-phenylbut- | 25 | 10 |
| | 3-en-1-amine | | |
| | n-butyl acrylate | 50 | 20 |
| | 2-ethylhexyl acrylate | 175 | 70 |
| Reactor | Deionized water | 5 | |
| initiator | Sodium persulfate | 0.292 | 0.12 |
| solution | | | |
| Feed | Deionized water | 11.1 | |
| initiator | Sodium persulfate | 0.875 | 0.35 |
| solution | | | |
| Promoter | Iron sulfate (II) heptahydrate | 0.83 | 0.0005 |
| Peroxide | Deionized water | 10 | |
| | t-butyl hydrogenperoxide | 0.5 | 0.14 |
| | (70%) (TBPH) | | |
| Reductant | Deionized water | 10.25 | |
| | Sodium formaldehyde sulfoxylate | 0.25 | 0.1 |

| | |
|---|---|
| Total batch (g) | 954 |
| Total monomer (g) | 250 |
| Theoretical solid (%) | 26.7 |
| Surfactant (%) | 1% vs. total monomer |
| Initiator (%) | 0.47% vs. total monomer |

| | | |
|---|---|---|
| 1^{st} monomer | min | 60 |
| emulsion feed | mL/min | 2.00 |
| 2^{nd} monomer | min | 90 |
| emulsion feed | mL/min | 3.50 |
| Feed Initiator | mL/min | 0.067 |
| | min | 180 |
| | mL | 11.5 |
| Redox initiator | min | 20 |
| | mL/min | 0.409 |
| | ° C. | 70 |
| | g | 10.5 |

### Example 9. Seeded Emulsion Polymerization of N-benzyl-N-methyl-3-phenylbut-3-en-1-amine with Styrene and n-butyl Methacrylate (EX 9)

The polymerization was conducted in a similar fashion as Example 1 above with the following changes: 15.3 g of a pre-formed seed latex was used in step 4 in place of 10.3 g of monomer emulsion; the reaction was held at 88° C. for 3 hours after the monomer emulsion and reactor initiator feeding was completed; post polymerization treatment using the combination of iron sulfate heptahydrate/TBPH/sodium formaldehyde sulfoxylate was not carried out.

M01491 The pre-formed seed latex was prepared from an emulsion polymerization of methyl methacrylate, butyl acrylate, and methacrylic acid using the same procedure as described above. The solid content is 41.3 wt %. The particle size is 25.7 nm.

| | | Amount | wt % vs. total |
|---|---|---|---|
| | | (g) | monomers |
| Initial | Deionized water | 320 | |
| charge | Sodium dodecyl sulfate | 2.52 | 0.63 |
| | Sodium carbonate | 1.6 | 0.4 |
| Monomer | Deionized water | 196 | 65 |
| Emulsion | Sodium dodecyl sulfate | 1.48 | 0.37 |
| | Methyl methacrylate | 312 | 78 |
| | Methacrylic acid | 4 | 1 |
| | Butyl acrylate | 84 | 21 |
| | n-dodecyl mercaptan | 0.4 | 0.1 |
| Reactor | Deionized water | 8 | |
| initiator | Sodium persulfate | 1.4 | 0.35 |
| solution | | | |
| Feed | Deionized water | 20 | |
| initiator | Sodium persulfate | 0.2 | 0.05 |
| solution | | | |
| Promoter | Iron sulfate (II) heptahydrate | 1.33 | 0.0005 |
| Peroxide | Deionized water | 17.5 | |
| | t-butyl hydrogenperoxide | 0.8 | 0.14 |
| | (70%) (TBPH) | | |
| Reductant | Deionized water | 18.3 | |
| | Sodium formaldehyde sulfoxylate | 0.4 | 0.1 |

| | | |
|---|---|---|
| 1^{st} monomer | min | 20 |
| emulsion feed | mL/min | 5.1 |
| 2^{nd} monomer | min | 50 |
| emulsion feed | mL/min | 10.2 |
| Feed Initiator | mL/min | 0.2 |
| | min | 100 |
| | mL | 20 |
| Redox initiator | min | 20 |
| | mL/min | 0.915 |
| | ° C. | 70 |
| | g | 18.3 |

### Example 2. Preparation of Aqueous Dispersion of Crosslinked Polymer Derived from N,N-dimethyl-3-phenylbut-3-en-1-amine with Styrene and n-butyl Methacrylate (EX 2)

(1) To a 1000 mL jacketed glass reactor equipped with overhead stirrer (dual impellers), reflux condenser, N2 blanket, and PTFE feed lines, was added deionized water and sodium dodecyl sulfate (initial charge). The reactor was heated to 88° C. under N₂.
(2) To a 1000 mL glass reactor equipped with overhead stirrer and N₂ blanket are added deionized water (152.5 g), sodium dodecylsulfate (SDS) (0.925 g), 5 wt % sodium hydroxide solution (10 g), and the monomer mixture comprising of N,N-dimethyl-3-phenylbut-3-en-1-amine (25 g), n-butyl methacrylate (197.5 g), and styrene (25 g). The reactor was then mixed at 400-500 rpm for at least 15 min to achieve a stable monomer emulsion.
(3) Two initiator solutions were prepared: (1) reactor initiator containing 0.292 g sodium persulfate in 5 g deionized water; (2) feed initiator containing 0.875 g sodium persulfate in 11.1 g deionized water.
(4) When the initial charge mixture reached the required temperature, 2.5 wt % of the monomer emulsion (10.3 g) and the full volume of the reactor initiator solution were added.
(5) Immediately after, 2.5 g of 1,6-hexanediol dimethacrylate was added into the monomer emulsion and mixed at 450 rpm.
(6) The reaction was held at 88° C. for 10 min, after which the monomer emulsion and feed initiator solution were fed to the reactor over ˜3 hours per the table below.
(7) The reaction was held at 88° C. overnight.
(8) The resulting reaction mixture was cooled to ˜50° C. and filtered through cheese cloth. The solid content is ˜27 wt %.

| | | Amount | wt % vs. total |
|---|---|---|---|
| | | (g) | monomers |
| Initial charge | Deionized water | 500 | 200 |
| | Sodium dodecyl sulfate | 1.575 | 0.63 |
| Monomer | Deionized water | 152.5 | 65 |
| Emulsion | Sodium dodecyl sulfate | 0.925 | 0.37 |
| | N,N-dimethyl-3-phenylbut- | 25 | 10 |
| | 3-en-1-amine | | |
| | n-butyl methacrylate | 197.5 | 79 |
| | styrene | 25 | 10 |
| | 1,6-hexanediol | 2.5 | 1 |
| | dimethacrylate | | |
| Reactor | Deionized water | 5 | |
| initiator | Sodium persulfate | 0.292 | 0.12 |
| solution | | | |
| Feed initiator | Deionized water | 11.1 | |
| solution | Sodium persulfate | 0.875 | 0.35 |

| | |
|---|---|
| Total batch (g) | 932.3 |
| Total monomer (g) | 250 |
| Theoretical solid (%) | 27.3 |
| Surfactant (%) | 1% vs. total monomer |
| Initiator (%) | 0.47% vs. total monomer |

| | | |
|---|---|---|
| 1^{st} monomer | min | 60 |
| emulsion feed | mL/min | 2.00 |
| 2^{nd} monomer | min | 90 |
| emulsion feed | mL/min | 3.50 |
| Feed Initiator | mL/min | 0.067 |
| | min | 180 |
| | mL | 11.5 |

Other inventive examples for the preparation of linear (EXAMPLES 3, 6, 7, 8) and crosslinked (EXAMPLES 4, 5) polymers as aqueous dispersions were conducted in a similar fashion except that the post polymerization treatment using the combination of iron sulfate heptahydrate/TBPH/sodium formaldehyde sulfoxylate was not used. Examples 3, 4, 5 and 8 were held overnight at 88-C. The total amount of monomers in all inventive examples was kept at 250 g.

All polymer products were characterized for particle sizes via Dynamic Light Scattering, conversion via gravimetric analysis, and molecular weight via Gel Permeation Chromatography (GPC) and the results are shown in the table below.

| | | | | | Monomer |
|---|---|---|---|---|---|
| | Amine containing | | | | composition |
| | monomer | Co-monomer 1 | Co-monomer 2 | Co-monomer 3 | (wt ratio)² |
| EX 1 | N,N-dimethyl-3- | n-butyl | 2-ethylhexyl | — | 10/20/70 |
| | phenylbut-3-en-1-amine | acrylate | acrylate | | |
| EX 2 | N,N-dimethyl-3- | styrene | n-butyl | 1,6- | 10/10/79/1 |
| | phenylbut-3-en-1-amine | | methacrylate | hexanediol | |
| | | | | dimethacrylate | |
| EX 3¹ | N-benzyl-N-methyl-3- | styrene | n-butyl | | 10/10/80 |
| | phenylbut-3-en-1-amine | | methacrylate | | |
| EX 4¹ | N,N-bis(2- | styrene | n-butyl | 1,6- | 10/10/79/1 |
| | methoxyethyl)-3- | | methacrylate | hexanediol | |
| | phenylbut-3-en-1-amine | | | dimethacrylate | |
| EX 5¹ | 2-(3-phenylbut-3-en-1- | styrene | n-butyl | 1,6- | 10/10/79/1 |
| | yl)-1,2,3,4- | | methacrylate | hexanediol | |
| | tetrahydroisoquinoline | | | dimethacrylate | |
| EX 6 | 1-methyl-4-(3-phenylbut- | styrene | n-butyl | t-butyl | 10/10/1/79 |
| | 3-en-1-yl)piperazine | | methacrylate | methacrylate | |
| EX 7 | — | n-butyl | 2-ethylhexyl | — | 0/22/78 |
| | | acrylate | acrylate | | |
| EX 8¹ | N,N-dimethyl-3- | n-butyl | 2-ethylhexyl | — | 10/20/70 |
| | phenylbut-3-en-1-amine | methacrylate | methacrylate | | |
| EX 9 | N-benzyl-N-methyl-3- | styrene | n-butyl | — | 10/10/80 |
| | phenylbut-3-en-1-amine | | methacrylate | | |

| | | Particle size | Conversion | | | |
|---|---|---|---|---|---|---|
| | Architecture | (DLS, r, nm) | (%) | Mₙ | M_{w} | M_{w}/Mₙ |
| EX 1 | Linear | 90 | 80 | 42,200 | 86,600 | 2.1 |
| EX 2 | Crosslinked | 45 | 80 | 34,200 | 58,700 | 1.7 |
| EX 3¹ | Linear | 10 | 98 | 42,400 | 94,600 | 2.23 |
| EX 4¹ | Crosslinked | 10 | 98 | 38,100 | 94,200 | 2.48 |
| EX 5¹ | Crosslinked | 8 | 51 | 18,900 | 48,600 | 2.56 |
| EX 6 | Linear | 14 | 66 | 108,300 | 244,600 | 2.26 |
| EX 7 | Linear | 45 | 98 | 28,700 | 63,800 | 2.22 |
| EX 8¹ | Linear | 9 | 84 | 66,100 | 126,300 | 1.91 |
| EX 9 | Linear | 48 | 74 | — | — | — |

¹Reactions were held overnight at 88° C.
²Monomer composition: amine containing monomer / co-monomer 1 / co-monomer 2 / co-monomer 3

All documents described herein are incorporated by reference herein, including any priority documents and/or testing procedures, to the extent they are not inconsistent with this text. As should be apparent from the foregoing general description and the specific embodiments, while forms of the invention have been illustrated and described, various modifications can be made without departing from the spirit and scope of the invention. Accordingly, it is not intended that the invention be limited thereby. The term “comprising” specifies the presence of stated features, steps, integers, or components, but does not preclude the presence or addition of one or more other features, steps, integers, components, or groups thereof. As such, the term “comprising” is considered essentially synonymous with the term “including.” Similarly, whenever a composition, an element, or a group of elements is preceded with the transitional phrase “comprising,” it should be understood that the same composition or group of elements is contemplated with transitional phrases “consisting essentially of,” “consisting of,” “selected from the group of consisting of,” or “can be”/“may be”/“is” preceding the recitation of the composition, element, or elements, and vice versa. In juxtaposition to the well-known terms “comprising” meaning “including what follows and anything else” [open] and “consisting of” meaning “including only what follows” [closed], the term “consisting essentially of” should be understood to be semi-inclusive and to mean, in accordance with US judicial interpretation, including that which follows and other things that do not materially affect the basic and novel properties.

Applicants have attempted to disclose all embodiments and applications of the disclosed subject matter that could be reasonably foreseen. However, there may be unforeseeable, insubstantial modifications that remain as equivalents. While the present invention has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

All patents, test procedures, and other documents cited herein, including priority documents, are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

What is claimed is:

1. An aqueous based copolymer emulsion composition, comprising:
i) from 1 to 60 wt. % of one or more copolymers comprising:
(a) one or more amine-derivatized alpha-methyl styrene (ADAMS) repeat units according to structure (II): 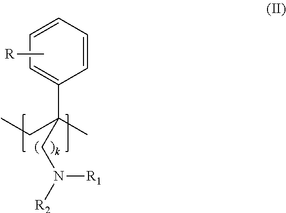
wherein:
k is an integer from 1 to 3;
R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof;
(b) one or more repeat units selected from the group of structures (III): 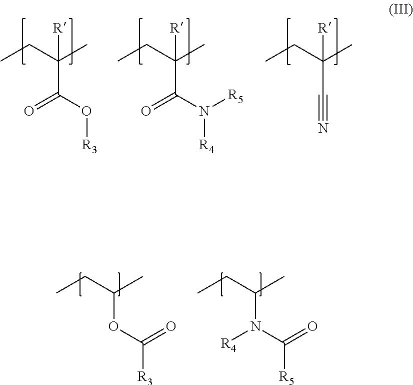
and combinations thereof, wherein:
R′ is a hydrogen or methyl group;
R₃, R₄, and R₅ are each independently a hydrogen atom, a hydrocarbyl group having 1 to 30 carbon atoms, or a hydrocarbonaceous group having 1 to 30 carbon atoms and 1 to 6 additional heteroatoms selected from the group consisting of O, N, S, P, Si, and combinations thereof, or
wherein R₃ is a hydrocarbyl or hydrocarbonaceous polymer having number-average molecular weight below 10,000 Da and optionally additional heteroatoms selected from the group of O, N, S, P, Se, or a combination thereof, or
wherein R₄ and R₅ are connected to form a moiety containing at least one 5- to 12-membered ring, from 3 to 30 carbon atoms, and optionally 1 to 6 additional heteroatoms selected from the group consisting of O, N, S, P, Si, or a combination thereof; and
(ii) from 0.05 to 5.0 wt. % of one or more one or more surfactants selected from the group consisting of anionic surfactants, cationic surfactants, nonionic surfactants, amphoteric surfactants, and combinations thereof; and
(iii) the remainder of the composition comprising water.

2. The composition of claim 1, wherein k=2.

3. The composition of claim 1, wherein the one or more ADAMS repeat units according to structure (II) comprise the reacted form of 1-dimethylamino-3-phenylbut-3-ene, 1-diethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl)amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-phenylbut-3-ene, 1-(N-piperidinyl)-3-phenylbut-3-ene, 1-(N-piperazinyl)-3-phenylbut-3-ene, 1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazinyl)-3-phenylbut-3-ene, 1-(5-methyl-2,5-diazabicyclo[2.2.1]heptan-2-yl)-3-phenylbut-3-ene, 1-(5-methyl-2,5-diazabicyclo[2.2.2]octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1-piperazinyl)-3-phenylbut-3-ene, 1-(N′-methyl-N-diazepanyl)-3-phenylbut-3-ene, N,N′-bis(3-phenylbut-3-enyl)diazepane, N,N′-bis(3-phenylbut-3-enyl)piperazine, N,N′-bis(3-phenylbut-3-enyl)dihydrophenazine, N,N′-bis(3-phenylbut-3-enyl)dihydrobenzoindazole, N,N′-bis(3-phenylbut-3-enyl)dihydropermidine, N,N′-bis(3-phenylbut-3-enyl)octahydropyridoquinoline, N,N′-bis(3-phenylbut-3-enyl)octahydropyridoisoquinoline, N,N′-bis(3-phenylbut-3-enyl)hexahydropyrroloquinoline, N,N′-bis(3-phenylbut-3-enyl)hexahydropyrroloisoquinoline, N,N′-bis(3-phenylbut-3-enyl)hexahydropyrroloisoindole, N,N′-bis(3-phenylbut-3-enyl)diazabicyclo[2.2.1]heptane, N,N′-bis(3-phenylbut-3-enyl)diazabicyclo[2.2.2]octane, 1,3-bis(1-(3-phenylbut-3-enyl)piperidin-4-yl)propane, bis(1-dimethylamino-3-phenylbut-3-enyl)benzene, bis(1-benzylmethylamino-3-phenylbut-3-enyl)benzene, bis(1-(N-morpholinyl)-3-phenylbut-3-enyl)benzene, bis(1-(N-thiomorpholinyl)-3-phenylbut-3-enyl)benzene, bis(1-(di-methoxyethyl)amino-3-phenylbut-3-enyl)benzene, bis(1-(N-piperidinyl)-3-phenylbut-3-enyl)benzene, bis(1-(N-pyrrolidinyl)-3-phenylbut-3-enyl)benzene, bis(1-(4-methyl-1-piperazinyl))-3-phenylbut-3-enyl)benzene, or a combination thereof.

4. The composition of claim 1, wherein the one or more repeat units selected from the group of structures (III) comprise the reacted form of acrylates, methacrylates, acrylamides, methacrylamides, acrylonitriles, methacrylonitriles, 0-vinyl esters, N-vinyl amides, and combinations thereof.

5. The composition of claim 1, further comprising one or more additional repeat units comprising the reacted form of styrene, alpha-methylstyrene, para-methylstyrene, 2-vinylpyridine, 3-vinylpyridine, 4-vinylpyridine, or a combination thereof.

6. The composition of claim 1, further comprising one or more additional repeat units according to structure (IV): 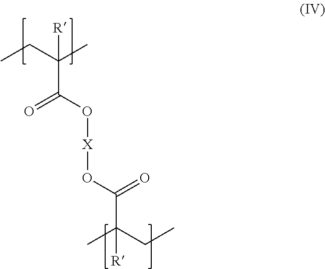
wherein:
R′ is a hydrogen or methyl;
X is a hydrocarbyl group or a hydrocarbonaceous group having 1 to 20 additional heteroatoms selected from the group consisting of O, N, S, P, Se, and combinations thereof, or wherein X is a hydrocarbyl or hydrocarbonaceous polymer having number-average molecular weight below 10,000 Da and optionally additional heteroatoms selected from the group of O, N, S, P, Se, or a combination thereof.

7. The composition of claim 1, wherein an amino group in one or more repeat units of structure (II) are protonated or alkylated to their corresponding ammonium salt.

8. The composition of claim 7, wherein the protonated or alkylated ammonium salt comprises a chloride, bromide, iodide, alkyl or aryl sulfonate, sulfate, phosphate, formate, acetate, propionate, butyrate, benzoate, triflate, nitrate counterion, or a combination thereof.

9. The composition of claim 1, wherein the one or more anionic or cationic surfactants are selected from the group consisting of sodium dodecyl sulfonate, alkyl surfactants, fluorine surfactants, metal surfactants, and combinations thereof.

10. The composition of claim 1, wherein the one or more non-ionic surfactants are selected from the group consisting of silicone surfactants, fluorine surfactants, alkyl surfactants, polyether-based surfactants, and combinations thereof.

11. The composition of claim 1, wherein the particle size of the one or more copolymers is from 20 to 1000 nm.

12. The composition of claim 1, wherein the pH the composition is from 2 to 12.

13. The composition of claim 1, wherein the viscosity of the composition is from 200 to 2000 cP at 25 deg. C. as measured by ASTM D5133.

14. The composition of claim 1 including from 4 to 20 wt. % of the one or more copolymers and from 80 to 96 wt % water.

15. The composition of claim 1, wherein an electrical conductivity of a polymer film of the composition is from 0 to 1 mS/cm.

16. The composition of claim 1, wherein the one or more copolymers have a number average molecular weight of from 2000 daltons to 5,000,000 daltons.

17. An aqueous based copolymer emulsion composition comprising:
i) from 1 to 60 wt. % of one or more copolymers comprising:
(a) the reaction product of one or more monomers according to structure (I) 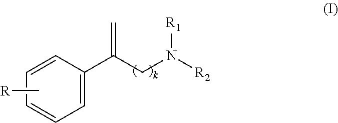
wherein:
k is an integer from 1 to 3;
R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof; and
(b) the reaction product of one or more monomers selected from the group consisting of optionally substituted acrylates, methacrylates, acrylamides, methacrylamides, acrylonitriles, methacrylonitriles, 0-vinyl esters, N-vinyl amides, or combinations thereof;
(ii) from 0.05 to 5.0 wt. % of one or more surfactants selected from the group consisting of anionic surfactants, cationic surfactants, nonionic surfactants, amphoteric surfactants, and combinations thereof; and
(iii) the remainder of the composition comprising water.

18. The composition of claim 17, wherein the one or more monomers according to structure (I) comprise 1-dimethylamino-3-phenylbut-3-ene, 1-diethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl)amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-phenylbut-3-ene, 1-(N-piperidinyl)-3-phenylbut-3-ene, 1-(N-piperazinyl)-3-phenylbut-3-ene, 1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazinyl)-3-phenylbut-3-ene, 1-(5-methyl-2,5-diazabicyclo[2.2.1]heptan-2-yl)-3-phenylbut-3-ene, 1-(5-methyl-2,5-diazabicyclo[2.2.2]octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1-piperazinyl)-3-phenylbut-3-ene, 1-(N′-methyl-N-diazepanyl)-3-phenylbut-3-ene, N,N′-bis(3-phenylbut-3-enyl)diazepane, N,N′-bis(3-phenylbut-3-enyl)piperazine, N,N′-bis(3-phenylbut-3-enyl)dihydrophenazine, N,N′-bis(3-phenylbut-3-enyl)dihydrobenzoindazole, N,N′-bis(3-phenylbut-3-enyl)dihydropermidine, N,N′-bis(3-phenylbut-3-enyl)octahydropyridoquinoline, N,N′-bis(3-phenylbut-3-enyl)octahydropyridoisoquinoline, N,N′-bis(3-phenylbut-3-enyl)hexahydropyrroloquinoline, N,N′-bis(3-phenylbut-3-enyl)hexahydropyrroloisoquinoline, N,N′-bis(3-phenylbut-3-enyl)hexahydropyrroloisoindole, N,N′-bis(3-phenylbut-3-enyl)diazabicyclo[2.2.1]heptane, N,N′-bis(3-phenylbut-3-enyl)diazabicyclo[2.2.2]octane, 1,3-bis(1-(3-phenylbut-3-enyl)piperidin-4-yl)propane, bis(1-dimethylamino-3-phenylbut-3-enyl)benzene, bis(1-benzylmethylamino-3-phenylbut-3-enyl)benzene, bis(1-(N-morpholinyl)-3-phenylbut-3-enyl)benzene, bis(1-(N-thiomorpholinyl)-3-phenylbut-3-enyl)benzene, bis(1-(di-methoxyethyl)amino-3-phenylbut-3-enyl)benzene, bis(1-(N-piperidinyl)-3-phenylbut-3-enyl)benzene, bis(1-(N-pyrrolidinyl)-3-phenylbut-3-enyl)benzene, bis(1-(4-methyl-1-piperazinyl))-3-phenylbut-3-enyl)benzene, or a combination thereof.

19. The composition of claim 17, wherein the one or more anionic or surfactants are selected from the group consisting of sodium dodecyl sulfonate, alkyl surfactants, fluorine surfactants, metal surfactants, and combinations thereof.

20. The composition of claim 17, wherein the one or more non-ionic surfactants are selected from the group consisting of silicone surfactants, fluorine surfactants, alkyl surfactants, polyether-based surfactants, and combinations thereof.

21. The composition of claim 17, wherein the particle size of the one or more copolymers is from 20 to 1000 nm.

22. The composition of claim 17, wherein the pH the composition is from 2 to 12.

23. The composition of claim 17, wherein the viscosity of the composition is from 200 to 2000 cP at 25 deg. C. as measured by ASTM D5133.

24. The composition of claim 17 including from 4 to 20 wt. % of the one or more copolymers and from 80 to 96 wt % water.

25. The composition of claim 17, wherein an electrical conductivity of a polymer film of the composition is from 0 to 1 mS/cm.

26. The composition of claim 17, wherein the one or more copolymers have a number average molecular weight of from 2,000 daltons to 5,000,000 daltons.

27. A method of making an amine containing copolymer via emulsion polymerization comprising the steps of:
(a) preparing a monomer emulsion mixture by combining one or more radically polymerizable monomers comprising
i) one or more monomers according to structure (I) 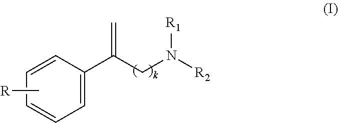
wherein:
k is an integer from 1 to 3;
R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof;
ii) one or more monomers selected from the group consisting of optionally substituted acrylates, methacrylates, acrylamides, methacrylamides, acrylonitriles, methacrylonitriles, 0-vinyl esters, N-vinyl amides, or combinations thereof; and
iii) one or more first emulsifiers in water, and optionally one or more pH buffers, and optionally one or more reaction modifiers;
(b) combining water, and optionally one or more second emulsifiers, and optionally one or more pH buffers, and the monomer emulsion mixtures of step (a) in a continuous or discontinuous manner to form a polymerization reaction mixture;
(c) adding one or more radical initiators, or a solution of one or more radical initiators, in a continuous or discontinuous manner, to the polymerization reaction mixture of step (b); and
(d) heating or cooling the polymerization reaction mixture of step (c) to a sufficient temperature, and for a sufficient time to form an amine containing copolymer.

28. The method of making a copolymer according to claim 27, further including a step (e) of adding a red/ox initiator system to the amine containing polymer of step (d) as a post-polymerization treatment.

29. The method of making a copolymer according to claim 28, wherein step (a), step (b), step (c), step (d), step (e), or a combination thereof are conducted under an inert gas atmosphere.

30. A method of using a copolymer comprising:
providing the copolymer according to claim 1, or an additive mixture including the copolymer according to claim 1, and
using the copolymer or the additive mixture including the copolymer in an application selected from the group consisting of a lithium-ion battery additive, a plastic additive, a drag reducing agent, a magneto-rheological fluid, an electro-chlorination additive, an industrial coating additive, an asphaltene and wax inhibitor, a refinery anti-foulant, an industrial or household surfactant, an agrochemical additive, a ceramic capacitor or inductor additive, an emulsion explosive additive, an anti-microbial coating, a crude transportation and refining additive, a carbon-capture additive, or a construction material additive.
